(19) United States
(12) Patent Application Publication
(10) Pub. No.: US 2024/0301099 A1
(43) Pub. Date: Sep. 12, 2024

(54) DUAL METALLOCENE POLYETHYLENE WITH IMPROVED ESCR FOR ROTOMOLDED, INJECTION MOLDED, AND RELATED PRODUCTS

(71) Applicant: Chevron Phillips Chemical Company LP, The Woodlands, TX (US)

(72) Inventors: Zhou Chen, Tulsa, OK (US); Richard M. Buck, Bartlesville, OK (US); Jon D. Ratzlaff, Bartlesville, OK (US); Jeffrey S. Fodor, Bartlesville, OK (US); Jim B. Askew, Barnsdall, OK (US)

(21) Appl. No.: 18/598,080

(22) Filed: Mar. 7, 2024

Related U.S. Application Data
(60) Provisional application No. 63/489,207, filed on Mar. 9, 2023.

(51) Int. Cl. C08F 10/02

(52) U.S. Cl. CPC C08F 10/02

(57) ABSTRACT

Ethylene-based polymers having a melt index from 0.8 to 8 g/10 min, a density from 0.94 to 0.96 g/cm³, and a ratio of Mw/Mn from 6 to 20 are disclosed. These polymers can have one or more of an environmental stress crack resistance (ESCR) of at least 5,000 hr (condition A, 100% Igepal), an ESCR of at least 2,500 hr (condition A, 10% Igepal), a CY-a parameter from 0.35 to 0.53, a PSP2 value from 5 to 8.5, a tan δ at 0.1 sec⁻¹ from 8 to 24 degrees, a Mz from 275,000 to 420,000 g/mol, an IVc from 2 to 3 dL/g, a strain hardening modulus (SHM) from 19 to 47 MPa, and/or an amount of polymer eluting between 93 and 95° C. in an ATREF profile of from 7 to 30 wt. %.

### REFERENCE TO RELATED APPLICATION

This application claims the benefit of U.S. Provisional Patent Application No. 63/489,207, filed on Mar. 9, 2023, the disclosure of which is incorporated herein by reference in its entirety.

### FIELD OF THE INVENTION

The present disclosure generally relates to metallocene-based bimodal ethylene polymers having excellent stress crack resistance, which can be utilized in a variety of rotomolding, injection molding, and related applications.

### BACKGROUND OF THE INVENTION

Polyolefins such as high density polyethylene (HDPE) homopolymer and copolymer and linear low density polyethylene (LLDPE) copolymer can be produced using various combinations of catalyst systems and polymerization processes for injection molding applications (e.g., caps and pails) and rotational molding applications (e.g., chemical tanks). However, polymer resins for these applications can readily crack and fail under various environmental stresses. Thus, there is a need for polyethylene resins with improved environmental stress crack resistance (ESCR), particularly at densities of 0.945 g/cm³ and above. Accordingly, it is to these ends that the present invention is generally directed.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Disclosed herein are high density ethylene-based polymers having excellent stress crack resistance. In an aspect, the ethylene polymer can have (or can be characterized by) a melt index in a range from 0.8 to 8 g/10 min, a ratio of Mw/Mn in a range from 6 to 20, and (i) a density in a range from 0.94 to 0.96 g/cm³ and an environmental stress crack resistance (ESCR) of at least 4,000 hr (ASTM D1693, condition A, 10% Igepal) and/or an environmental stress crack resistance (ESCR) of at least 7,000 hr (ASTM D1693, condition A, 100% Igepal), or (ii) a density in a range from 0.949 to 0.96 g/cm³ and an environmental stress crack resistance (ESCR) of at least 2,500 hr (ASTM D1693, condition A, 10% Igepal) and/or an environmental stress crack resistance (ESCR) of at least 5,000 hr (ASTM D1693, condition A, 100% Igepal).

In another aspect, the ethylene polymer can have (or can be characterized by) a melt index in a range from 0.8 to 8 g/10 min, a density in a range from 0.94 to 0.96 g/cm³, a ratio of Mw/Mn in a range from 6 to 20, and a CY-a parameter in a range from 0.35 to 0.53. In another aspect, the ethylene polymer can have (or can be characterized by) a melt index in a range from 0.8 to 8 g/10 min, a density in a range from 0.94 to 0.96 g/cm³, a ratio of Mw/Mn in a range from 6 to 20, and a PSP2 value in a range from 5 to 8.5. In another aspect, the ethylene polymer can have (or can be characterized by) a melt index in a range from 0.8 to 8 g/10 min, a density in a range from 0.94 to 0.96 g/cm³, a ratio of Mw/Mn in a range from 6 to 20, and from 7 to 30 wt. % of the polymer eluting between 93 and 95° C. in an ATREF profile. In another aspect, the ethylene polymer can have (or can be characterized by) a melt index in a range from 0.8 to 8 g/10 min, a density in a range from 0.94 to 0.96 g/cm³, a ratio of Mw/Mn in a range from 6 to 20, and an IVc from 2 to 3 dL/g. In another aspect, the ethylene polymer can have (or can be characterized by) a melt index in a range from 0.8 to 8 g/10 min, a density in a range from 0.94 to 0.96 g/cm³, a ratio of Mw/Mn in a range from 6 to 20, and a strain hardening modulus (SHM) in a range from 19 to 47 MPa.

In yet another aspect, the ethylene polymer can have (or can be characterized by) a melt index in a range from 2 to 8 g/10 min, a density in a range from 0.94 to 0.96 g/cm³, a ratio of Mw/Mn in a range from 6 to 20, and a tan δ at 0.1 sec⁻¹ in a range from 8 to 24 degrees. In still another aspect, the ethylene polymer can have (or can be characterized by) a melt index in a melt index in a range from 2 to 8 g/10 min, a density in a range from 0.948 to 0.96 g/cm³, a ratio of Mw/Mn in a range from 6 to 20, and a Mz in a range from 275,000 to 420,000 g/mol.

These ethylene polymers can be used to produce various articles of manufacture, such as injected molded products, rotational molded products, injection stretch blow molded products, and the like.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURES

FIG. 1 presents a plot of the molecular weight distributions of the polymers of Examples 1-13 and Comparative Examples C1-C2.

FIG. 2 presents a dynamic rheology plot (viscosity versus shear rate) at 190° C. for the polymers of Examples 1-13 and Comparative Examples C1-C2.

FIG. 3 presents a plot of the ATREF profiles of the polymers of Examples 1-13 and Comparative Examples C1-C2.

FIG. 4 presents a plot of ESCR (condition A, 10% Igepal) versus the percentage of polymer eluted in the 93-95° C. range in an ATREF test for the polymers of Examples 1-13.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the polymer compositions and/or methods described herein are contemplated with or without explicit description of the particular combination. Additionally, unless explicitly recited otherwise, any aspect and/or feature disclosed herein can be combined to describe inventive features consistent with the present disclosure.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

The terms “a,” “an,” “the,” etc., are intended to include plural alternatives, e.g., at least one, unless otherwise specified.

The terms “contacting” and “combining” are used herein to describe compositions and processes/methods in which the materials are contacted or combined together in any order, in any manner, and for any length of time, unless otherwise specified. For example, the materials can be blended, mixed, slurried, dissolved, reacted, treated, impregnated, compounded, or otherwise contacted or combined in some other manner or by any suitable method or technique.

The term “hydrocarbon” refers to a compound containing only carbon and hydrogen. Other identifiers can be utilized to indicate the presence of particular groups in the hydrocarbon (e.g., halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

The term “polymer” is used herein generically to include olefin homopolymers, copolymers, terpolymers, and the like, as well as alloys and blends thereof. The term “polymer” also includes impact, block, graft, random, and alternating copolymers. A copolymer is derived from an olefin monomer and one olefin comonomer, while a terpolymer is derived from an olefin monomer and two olefin comonomers. Accordingly, “polymer” encompasses copolymers and terpolymers derived from any olefin monomer and comonomer(s) disclosed herein. Similarly, the scope of the term “polymerization” includes homopolymerization, copolymerization, and terpolymerization. Therefore, an ethylene polymer includes ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an ethylene copolymer can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, unless stated otherwise, and such configurations can include isotactic, syndiotactic, and random symmetries. Moreover, unless stated otherwise, the term “polymer” also is meant to include all molecular weight polymers and is inclusive of lower molecular weight polymers.

The terms “catalyst composition,” “catalyst mixture,” “catalyst system,” and the like, do not depend upon the actual product or composition resulting from the contact or reaction of the initial components of the disclosed or claimed catalyst composition (or catalyst system), the nature of the active catalytic site, or the fate of the co-catalyst, catalyst component I, catalyst component II, or the activator (e.g., activator-support), after combining these components. Therefore, the terms “catalyst composition,” “catalyst mixture,” “catalyst system,” and the like, encompass the initial starting components of the composition, as well as whatever product(s) may result from contacting these initial starting components, and this is inclusive of both heterogeneous and homogenous catalyst systems or compositions. The terms “catalyst composition,” “catalyst mixture,” “catalyst system,” and the like, can be used interchangeably throughout this disclosure.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the ethylene polymer can have various ratios of Mw/Mn in aspects of this invention. By a disclosure that the ratio of Mw/Mn is in a range from 6 to 20, the intent is to recite that the ratio of Mw/Mn can be any ratio in the range and, for example, can include any range or combination of ranges from 6 to 20, such as from 6 to 18, from 6 to 16, from 7 to 20, from 7 to 18, from 8 to 18, from 8 to 16, from 9 to 20, or from 9 to 16, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

The present disclosure is directed generally to dual metallocene catalyst systems, methods for using the catalyst systems to polymerize olefins, the polymer resins produced using such catalyst systems, and molded products and other articles of manufactures produced using these polymer resins. In particular, the present invention relates to metallocene-based bimodal ethylene polymers having excellent stress crack resistance, as quantified by environmental stress crack resistance (ESCR) using condition A and either 100% Igepal or 10% Igepal.

An objective of this invention is to produce ethylene polymers having a high density (greater than 0.94 g/cm³) in combination with exceptional ESCR values of at least 1,000 hr, and more often, at least 2,500 hr, at least 5,000 hr, at least 7,000 hr, or at least 10,000 hr.

It is difficult to achieve high ESCR in combination with even higher densities (greater than 0.948-0.950 g/cm³) and higher melt indices (greater than 2 g/10 min). Therefore, another objective of invention is to produce ethylene polymers having these densities and melt indices in combination with exceptional ESCR values of at least 1,000 hr, and more often, at least 2,500 hr, at least 5,000 hr, at least 7,000 hr, or at least 10,000 hr.

Another objective of this invention is to produce ethylene polymers having exceptional ESCR values in combination with surprisingly high impact resistance, one measure of which is low temperature impact strength at −40° C., and to accomplish this at high polymer densities of at least 0.94 g/cm³, at least 0.948 g/cm³, at least 0.949 g/cm³, or at least 0.95 g/cm³.

It is believed that ethylene-based polymers having a melt index from 0.8 to 8 g/10 min (or from 2 to 8 g/10 min), a density from 0.94 to 0.96 g/cm³ (or from 0.948-0.950 to 0.96 g/cm³), and a ratio of Mw/Mn from 6 to 20 (or from 8 to 18) in combination with one or more of the following polymer attributes—a CY-a parameter from 0.35 to 0.53, a PSP2 value from 5 to 8.5, a tan δ at 0.1 sec⁻¹ from 8 to 24 degrees, a Mz from 275,000 to 420,000 g/mol, an IVc from 2 to 3 dL/g, a strain hardening modulus (SHM) from 19 to 47 MPa, and/or an amount of polymer eluting between 93 and 95° C. in an ATREF profile of from 7 to 30 wt. %—meet these objectives and also provide additional benefits that are disclosed herein.

### Ethylene Polymers

Generally, the polymers disclosed herein are ethylene-based polymers, or ethylene polymers, encompassing homopolymers of ethylene as well as copolymers, terpolymers, etc., of ethylene and at least one olefin comonomer. Comonomers that can be copolymerized with ethylene often can have from 3 to 20 carbon atoms in their molecular chain. For example, typical comonomers can include, but are not limited to, propylene, 1-butene, 1-pentene, 1-hexene, 1-heptene, 1-octene, and the like, or combinations thereof. In an aspect, the olefin comonomer can comprise a C₃-C₁₈ olefin; alternatively, the olefin comonomer can comprise a C₃-C₁₀ olefin; alternatively, the olefin comonomer can comprise a C₄-C₁₀ olefin; alternatively, the olefin comonomer can comprise a C₃-C₁₀ α-olefin; alternatively, the olefin comonomer can comprise a C₄-C₁₀ α-olefin; alternatively, the olefin comonomer can comprise 1-butene, 1-hexene, 1-octene, or any combination thereof; or alternatively, the comonomer can comprise 1-hexene. Typically, the amount of the comonomer, based on the total weight of monomer (ethylene) and comonomer, can be in a range from 0.01 to 20 wt. %, from 0.01 to 1 wt. %, from 0.5 to 15 wt. %, from 0.5 to 2 wt. %, or from 1 to 15 wt. %.

In one aspect, the ethylene polymer of this invention can comprise an ethylene/α-olefin copolymer, while in another aspect, the ethylene polymer can comprise an ethylene homopolymer, and in yet another aspect, the ethylene polymer of this invention can comprise an ethylene/α-olefin copolymer and an ethylene homopolymer. For example, the ethylene polymer can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer.

An illustrative and non-limiting example of a first ethylene polymer (e.g., comprising an ethylene copolymer) consistent with the present invention can have (or can be characterized by) a melt index in a range from 0.8 to 8 g/10 min and a ratio of Mw/Mn in a range from 6 to 20. In some aspects, the first ethylene polymer can have (i) a density in a range from 0.94 to 0.96 g/cm³ and (a) an environmental stress crack resistance (ESCR) of at least 4,000 hr (ASTM D1693, condition A, 10% Igepal), or (b) an environmental stress crack resistance (ESCR) of at least 7,000 hr (ASTM D1693, condition A, 100% Igepal), or both (a) and (b). In other aspects, the first ethylene polymer can have a (ii) a density in a range from 0.949 to 0.96 g/cm³ and (a) an environmental stress crack resistance (ESCR) of at least 2,500 hr (ASTM D1693, condition A, 10% Igepal), or (b) an environmental stress crack resistance (ESCR) of at least 5,000 hr (ASTM D1693, condition A, 100% Igepal), or both (a) and (b). The ESCR test is typically stopped after a certain number of hours is reached, and given the long duration of the test, the upper limit of ESCR (in hours) is generally not determined. Thus, these are minimum threshold values, since generally the maximum value is not determined, so long as the minimum threshold value is exceeded.

An illustrative and non-limiting example of a second ethylene polymer consistent with the present invention can have (or can be characterized by) a melt index in a range from 0.8 to 8 g/10 min, a density in a range from 0.94 to 0.96 g/cm³, a ratio of Mw/Mn in a range from 6 to 20, and a CY-a parameter in a range from 0.35 to 0.53. Within a given catalyst type, higher CY-a values have been observed to be associated with lower levels of long chain branching (LCB), and lower CY-a also can result from less of a high MW tail. Thus, the better stress crack resistance in the claimed CY-a range can be a balance of these factors with a relatively low molecular weight (given that the overall polymer melt index is relatively high).

An illustrative and non-limiting example of a third ethylene polymer consistent with the present invention can have (or can be characterized by) a melt index in a range from 0.8 to 8 g/10 min, a density in a range from 0.94 to 0.96 g/cm³, a ratio of Mw/Mn in a range from 6 to 20, and a PSP2 value in a range from 5 to 8.5. PSP2 is a measure of the average tie molecule population. In general, the higher the PSP2, the more tie molecules and the better the slow crack growth and stress crack resistance properties. However, lower melt index and lower density tend to raise the PSP, thus the claimed PSP2 range likely represents a balance given the relatively high melt index and density.

An illustrative and non-limiting example of a fourth ethylene polymer consistent with the present invention can have (or can be characterized by) a melt index in a range from 0.8 to 8 g/10 min, a density in a range from 0.94 to 0.96 g/cm³, a ratio of Mw/Mn in a range from 6 to 20, and from 7 to 30 wt. % of the polymer eluting between 93 and 95° C. in an ATREF profile. It is believed that higher amounts of polymer eluting in the range from 93° C. to 95° C. correlate with improved stress crack resistance and higher ESCR values.

An illustrative and non-limiting example of a fifth ethylene polymer consistent with the present invention can have (or can be characterized by) a melt index in a range from 0.8 to 8 g/10 min, a density in a range from 0.94 to 0.96 g/cm³, a ratio of Mw/Mn in a range from 6 to 20, and an IVc from 2 to 3 dL/g. Higher IVc often can indicate an average higher molecular weight in solution and possibly higher average hydrodynamic radius, and generally IVc values coincide with higher Mw and Mz values. Although the polymer has a relatively high melt index, a certain amount of higher MW material within the polymer is likely needed to provide excellent stress crack resistance.

An illustrative and non-limiting example of a sixth ethylene polymer consistent with the present invention can have (or can be characterized by) a melt index in a range from 0.8 to 8 g/10 min, a density in a range from 0.94 to 0.96 g/cm³, a ratio of Mw/Mn in a range from 6 to 20, and a strain hardening modulus (SHM) in a range from 19 to 47 MPa. ISO 18488 describes the method for the determination of the strain hardening modulus (SHM), which can be used to quantify the resistance of ethylene polymers to slow crack growth. While not wishing to be bound by theory, it is believed that higher SHM values generally correlate with higher ESCR values.

An illustrative and non-limiting example of a seventh ethylene polymer consistent with the present invention can have (or can be characterized by) a melt index in a range from 2 to 8 g/10 min, a density in a range from 0.94 to 0.96 g/cm³, a ratio of Mw/Mn in a range from 6 to 20, and a tan δ at 0.1 sec⁻¹ in a range from 8 to 24 degrees.

An illustrative and non-limiting example of an eighth ethylene polymer consistent with the present invention can have (or can be characterized by) a melt index in a melt index in a range from 2 to 8 g/10 min, a density in a range from 0.948 to 0.96 g/cm³, a ratio of Mw/Mn in a range from 6 to 20, and a Mz in a range from 275,000 to 420,000 g/mol. It is believed that a higher Mz value is important for improved stress crack resistance and higher ESCR values, particular when viewed in combination with higher density and higher melt index.

These illustrative and non-limiting examples of the first ethylene polymer, the second ethylene polymer, the third ethylene polymer, the fourth ethylene polymer, the fifth ethylene polymer, the sixth ethylene polymer, the seventh ethylene polymer, and the eighth ethylene polymer consistent with the present invention also can have any of the polymer properties listed below and in any combination, unless indicated otherwise.

The melt index (MI) of these ethylene polymers, in some aspects, can be in a range from 0.8 to 6 g/10 min, from 1 to 8 g/10 min, from 1.5 to 8 g/10 min, from 1.5 to 6 g/10 min, from 2 to 8 g/10 min, or from 2 to 6 g/10 min. Additionally or alternatively, the high load melt index (HLMI) of these ethylene polymers often can range from 30 to 400 g/10 min, such as from 40 to 350 g/10 min, from 50 to 350 g/10 min, from 70 to 350 g/10 min, or from 70 to 300 g/10 min.

The ratio of HLMI/MI of the first ethylene polymer, the second ethylene polymer, the third ethylene polymer, the fourth ethylene polymer, the fifth ethylene polymer, the sixth ethylene polymer, the seventh ethylene polymer, and the eighth ethylene polymer can fall within a range from 25 to 75, from 25 to 68, from 28 to 75, or from 28 to 68 in some aspects, while in other aspects, the ratio of HLMI/MI of these polymers can range from 30 to 75; alternatively, from 30 to 70; or alternatively, from 30 to 65.

The densities of these ethylene-based polymers are greater than or equal to 0.94 g/cm³ and less than or equal to 0.96 g/cm³. Representative ranges for the density of these polymers can include from 0.942 to 0.96 g/cm³, from 0.945 to 0.96 g/cm³, from 0.945 to 0.958 g/cm³, from 0.945 to 0.956 g/cm³, from 0.948 to 0.96 g/cm³, from 0.948 to 0.958 g/cm³, from 0.949 to 0.96 g/cm³, or from 0.949 to 0.956 g/cm³.

In an aspect, these ethylene polymers can have a number-average molecular weight (Mn) in a range from 5,000 to 25,000 g/mol, such as from 5,000 to 20,000 g/mol, from 5,000 to 15,000 g/mol, from 5,000 to 10,000 g/mol, from 6,000 to 20,000 g/mol, from 6,000 to 15,000 g/mol, or from 6,000 to 10,000 g/mol, and the like. While not limited thereto, these ethylene polymers can have a weight-average molecular weight (Mw) in a range from 75,000 to 150,000 g/mol, from 75,000 to 120,000 g/mol, from 80,000 to 130,000 g/mol, from 80,000 to 110,000 g/mol, from 85,000 to 140,000 g/mol, from 85,000 to 130,000 g/mol, or from 85,000 to 110,000 g/mol. Additionally or alternatively, these ethylene polymers can have a z-average molecular weight (Mz) in a range from 240,000 to 420,000 g/mol, from 240,000 to 375,000 g/mol, from 240,000 to 350,000 g/mol, from 275,000 to 420,000 g/mol, from 275,000 to 390,000 g/mol, from 275,000 to 375,000 g/mol, or from 300,000 to 390,000 g/mol, and the like.

In an aspect, the ethylene polymers can have a ratio of Mw/Mn, or the polydispersity index, in a range from 6 to 20, such as from 6 to 18, from 6 to 16, from 7 to 20, from 7 to 18, from 8 to 18, from 8 to 16, from 9 to 20, or from 9 to 16, and the like. Additionally or alternatively, these ethylene polymers can have a ratio of Mz/Mw in a range from 2.2 to 4.2, from 2.4 to 4, from 2.4 to 3.8, from 2.6 to 4, from 2.6 to 3.8, or from 2.8 to 3.7, and the like.

In accordance with certain aspects of this invention, the IB parameter from a molecular weight distribution curve (plot of dW/d(Log M) vs. Log M; normalized to an area equal to 1) can be an important characteristic of the ethylene polymers described herein. The IB parameter is often referred to as the integral breadth, and is defined as 1/[dW/d(Log M)]_{MAX}, and is useful to describe the shape of the largest peak in a bimodal MWD: the largest peak is smaller/broader as the IB parameter increases. Generally, the IB parameter of the ethylene polymers consistent with this invention can, in one aspect, be in a range from 1.1 to 2.3. In another aspect, the ethylene polymer can be characterized by an IB parameter in a range from 1.2 to 2.2, and in another aspect, the IB parameter can range from 1.2 to 2.1, and in another aspect, the IB parameter can range from 1.4 to 2.2, and in yet another aspect, the IB parameter can range from 1.5 to 2.3, and in still another aspect, the IB parameter can range from 1.5 to 2.2.

While not being limited thereto, the ethylene polymers described herein can have an IVc (intrinsic viscosity determined by GPC) that typically falls within a range from 2 to 3.2. In one aspect, the IVc can be in a range from 2 to 3, while in another aspect, the IVc can be in a range from 2 to 2.8, and in another aspect, the IVc can be in a range from 2.1 to 3, and in another aspect, the IVc can be in a range from 2.1 to 2.8, and in yet another aspect, the IVc can be in a range from 2.1 to 2.6, and in still another aspect, the IVc can be in a range from 2.2 to 2.8 dL/g. For these ethylene polymers, IVc is generally correlated with Mw and Mz, and higher IVc values coincide generally with higher Mw and Mz values.

Ethylene polymers consistent with certain aspects of the invention can have a bimodal molecular weight distribution (as determined using gel permeation chromatography (GPC) or other related analytical technique). Often, in a bimodal molecular weight distribution, there is a valley between the peaks, and the peaks can be separated or deconvoluted. Typically, a bimodal molecular weight distribution can be characterized as having an identifiable high molecular weight component (or distribution) and an identifiable low molecular weight component (or distribution). Illustrative unimodal MWD curves and bimodal MWD curves are shown in U.S. Pat. No. 8,383,754.

Thus, in aspects of this invention, the first ethylene polymer, the second ethylene polymer, the third ethylene polymer, the fourth ethylene polymer, the fifth ethylene polymer, the sixth ethylene polymer, the seventh ethylene polymer, and the eighth ethylene polymer can comprise a high or higher molecular weight (HMW) component (or a first component) and a low or lower molecular weight (LMW) component (or a second component). These component terms are relative, are used in reference to each other, and are not limited to the actual molecular weights of the respective components. The molecular weight characteristics of these LMW and HMW components can be determined by deconvoluting the composite (overall polymer) molecular weight distribution (e.g., determined using gel permeation chromatography). While not limited thereto, the Mw (HMW) for these ethylene polymers can range from 100,000 to 300,000 g/mol, from 125,000 to 280,000 g/mol, from 150,000 to 250,000 g/mol, or from 160,000 to 230,000 g/mol, and the like. Additionally or alternatively, the Mn (HMW) for these ethylene polymers can range from 50,000 to 150,000 g/mol, from 50,000 to 100,000 g/mol, from 60,000 to 105,000 g/mol, or from 60,000 to 90,000 g/mol, and the like.

Referring now to the molecular weight distribution of the HMW component, the molecular weight distribution, as quantified by the ratio of Mw/Mn (HMW), is beneficially narrow. In one aspect, the higher molecular weight component has a ratio of Mw/Mn from 2 to 3, while in another aspect, the ratio of Mw/Mn is from 2 to 2.8, and in another aspect, the ratio of Mw/Mw is from 2 to 2.6, and in yet another aspect, the ratio of Mw/Mn is from 2.2 to 2.8, and in still another aspect, the ratio of Mw/Mn is from 2.3 to 2.7.

Referring now to the molecular weight distribution of the LMW component, the molecular weight distribution, as quantified by ratio of Mw/Mn (LMW), is narrow, but often not as narrow as that of the HMW component. In one aspect, the lower molecular weight component has a ratio of Mw/Mn from 2.8 to 4.6, while in another aspect, the ratio of Mw/Mn is from 2.8 to 4.4, and in another aspect, the ratio of Mw/Mw is from 3 to 4.3, and in yet another aspect, the ratio of Mw/Mn is from 3.3 to 4.4, and in still another aspect, the ratio of Mw/Mn is from 3.3 to 4.1. While not limited thereto, the Mw (LMW) for these ethylene polymers can range from 8,000 to 70,000 g/mol, from 8,000 to 26,000 g/mol, from 10,000 to 50,000 g/mol, from 10,000 to 26,000 g/mol, or from 12,000 to 30,000 g/mol, and the like.

The relative amounts of the LMW and HMW components are not particularly limited, but often the amount of the LMW component, based on the total polymer (HMW plus LMW), falls within a range of from 30 to 85 wt. %. Other typical amounts of the LMW component, based on the total polymer, can range from 30 to 75 wt. %, from 38 to 75 wt. %, from 40 to 75 wt. %, or from 40 to 70 wt. %, and the like.

Advantageously, the first ethylene polymer, the second ethylene polymer, the third ethylene polymer, the fourth ethylene polymer, the fifth ethylene polymer, the sixth ethylene polymer, the seventh ethylene polymer, and the eighth ethylene polymer have excellent stress crack resistance, particularly surprising given the relatively high polymer densities. In an aspect of this disclosure, these polymers can have an environmental stress crack resistance (ESCR) of at least 1,000 hr (ASTM D1693, condition A, 100% Igepal). However, more often, these polymers have ESCR values of at least 2,500 hr, at least 4,000 hr, at least 5,000 hr, at least 7,000 hr, or at least 10,000 hr (condition A, 100%). Using a more stringent test (ASTM D1693, condition A, 10% Igepal), these polymers can have an environmental stress crack resistance (ESCR) of at least 500 hr, and more typically, an ESCR of at least 1,000 hr or at least 2,500 hr. Unexpectedly, these polymers often can have an ESCR of at least 3,000 hr, at least 3,500 hr, or at least 4,000 hr (under condition A, 10%). The ESCR test is typically stopped after a certain number of hours is reached, and given the long duration of the test, the upper limit of ESCR (in hours) is generally not determined. These are minimum threshold values, since generally the maximum value is not determined, so long as the minimum threshold value is exceeded.

These ethylene polymers can have a strain hardening modulus (SHM) that falls within a range from 19 to 47 MPa. For instance, the SHM of these ethylene polymers can range from 19 to 45 MPa in one aspect, from 20 to 42 MPa in another aspect, from 20 to 40 MPa in another aspect, from 22 to 45 MPa in another aspect, from 22 to 42 MPa in yet another aspect, and from 22 to 40 MPa in still another aspect.

In an aspect, these ethylene polymers can have a CY-a parameter in a range from 0.3 to 0.6. Other suitable ranges for the CY-a parameter include, but are not limited to, from 0.35 to 0.55, from 0.35 to 0.53, from 0.4 to 0.55, from 0.4 to 0.53, or from 0.45 to 0.53, and the like. Additionally or alternatively, these ethylene polymers can have a relaxation time (Tau(eta) or τ(η)) in a range from 0.006 to 0.06 sec. Other suitable ranges for the relaxation time include, but are not limited to, from 0.008 to 0.05 sec, from 0.008 to 0.04 sec, from 0.01 to 0.05 sec, from 0.01 to 0.04 sec, or from 0.015 to 0.035 sec. A polymer relaxation time typically refers to the time it takes the polymer chains to return to equilibrium after being disturbed. Non-Newtonian fluids have a characteristic memory time scale which is referred to as the relaxation time. When the applied rate of deformation is reduced to zero, these materials relax over their characteristic relaxation time. A low Tau(eta) value is desirable because it corresponds to minimized stresses in the polymer during orientation such as in a molding process. Generally, Tau(eta) increases with molecular weight, however, the entanglements of the polymer, the long chain branching, the molecular weight, and the molecular weight distribution all influence the relaxation behavior. The CY-a and relaxation time parameters are determined from viscosity data measured at 190° C. and using the Carreau-Yasuda (CY) empirical model described herein.

While not limited thereto, the first ethylene polymer, the second ethylene polymer, the third ethylene polymer, the fourth ethylene polymer, the fifth ethylene polymer, the sixth ethylene polymer, the seventh ethylene polymer, and the eighth ethylene polymer can have a tan δ (tan d or tangent delta) at 0.1 sec⁻¹ in a range from 8 to 27 degrees. Other suitable ranges for the tan δ at 0.1 sec⁻¹ include, but are not limited to, from 8 to 24, from 9 to 22, from 10 to 24, from 12 to 24, or from 14 to 22 degrees, and the like. The (low frequency) tan δ at 0.1 sec⁻¹ of greater than 1, as opposed to less than 1, is indicative of a polymer with relatively low elasticity at low shear, which can be beneficial for certain molding applications, particularly for higher melt index polymers. Additionally or alternatively, these ethylene polymers can have a tan δ (tan d or tangent delta) at 100 sec⁻¹ that falls within a range from 0.7 to 1.5 degrees, and more often, from 0.8 to 1.4 degrees, from 0.8 to 1.2 degrees, from 0.9 to 1.4 degrees, or from 0.9 to 1.2 degrees, although not limited thereto. The tan δ rheological parameters are determined from viscosity data measured at 190° C. and using the Carreau-Yasuda (CY) empirical model described herein.

Additionally or alternatively, these ethylene polymers can have a ratio of η @0.1/η @ 100 at 190° C. (ratio of viscosity at 0.1 sec⁻¹ to the viscosity at 100 sec⁻¹) in a range from 3 to 7; alternatively, from 3 to 6.5; alternatively, from 3 to 6; alternatively, from 3.5 to 6; alternatively, from 3.5 to 5.5; or alternatively, from 3.5 to 5. This ratio is determined from viscosity data measured at 190° C. and using the Carreau-Yasuda (CY) empirical model described herein.

Beneficially, the amount of short chain branches (SCBs) in the higher molecular weight fraction of the polymer is much greater than the amount of SCBs in the lower molecular weight fraction of the polymer. This is often called a reverse comonomer distribution, and can be quantified by the relative amount of SCBs at Mz as compared to the amount of SCBs at Mn. In one aspect, the ratio of the number of SCBs per 1000 total carbon atoms at Mz to the number of SCBs per 1000 total carbon atoms at Mn can range from 1.8 to 5. In another aspect, this ratio can be in a range from 1.8 to 4, while in another aspect, the ratio can be in a range from 1.8 to 3.5, and in yet another aspect, the ratio can be in a range from 2 to 4, and in still another aspect, the ratio can be in a range from 2 to 3.6.

In accordance with certain aspects of this invention, the ethylene polymers described herein can have a unique analytic TREF (ATREF) profile. For instance, the ethylene polymer can have a peak ATREF temperature (temperature of the highest peak on the ATREF curve in the 40-110° C. range) of from 93° C. to 100° C. or from 94° C. to 99° C. In some aspects, the peak ATREF temperature can be in a range from 94° C. to 98° C., from 94° C. to 97° C., or from 95° C. to 98° C.

Unexpectedly, it was determined that ethylene polymers having a significant amount of polymer eluting in the range from 93° C. to 95° C. have improved stress crack resistance. Accordingly, the ethylene polymers encompassed herein (e.g., ethylene/α-olefin copolymers) can have an ATREF profile characterized by from 7 to 30 wt. % of the polymer eluting between 93° C. and 95° C., and more often, from 7 to 28 wt. %, from 9 to 30 wt. %, from 9 to 28 wt. %, from 12 to 30 wt. %, or from 14 to 28 wt. %, of the polymer eluting between 93° C. and 95° C. Additionally or alternatively, the ethylene polymer can have an ATREF profile characterized by from 0.25 to 7.5 wt. %, from 0.5 to 7 wt. %, from 1 to 7 wt. %, from 1.5 to 7 wt. %, or from 1.5 to 6.5 wt. %, of the polymer eluting below a temperature of 40° C.

Generally, ethylene polymers in aspects of the present invention are essentially linear or have very low levels of long chain branching, with typically less than or equal to 8 long chain branches (LCBs) per 1,000,000 total carbon atoms—using the Janzen-Colby model described herein. In some aspects, these ethylene polymers can contain less than or equal to 7 LCBs, less than or equal to 6 LCBs, or less than or equal to 5 LCBs, per 1,000,000 total carbon atoms.

The first ethylene polymer, the second ethylene polymer, the third ethylene polymer, the fourth ethylene polymer, the fifth ethylene polymer, the sixth ethylene polymer, the seventh ethylene polymer, and the eighth ethylene polymer can have a PSP4 value in a range from 0.2 to 0.9 and/or a PSP2 value in a range from 5 to 10. Information on the significance of the primary structure parameters PSP4 and PSP2, as well as methods for their determination, can be found in Polymer 147 (2018) 8-19; Polymer 153 (2018) 422-429; Polymer 180 (2019) 121730; and U.S. Pat. No. 8,492,498. Other typical ranges for the PSP4 value of these ethylene polymers include from 0.3 to 0.9, from 0.3 to 0.85, from 0.35 to 0.85, or from 0.4 to 0.8, and the like. Similarly, other typical ranges for the PSP2 values of these ethylene polymers include from 5 to 8.5, from 5 to 8, from 5.5 to 9, from 5.5 to 8.5, from 6 to 9.5, from 6 to 8.5, or from 6 to 8.3, and the like.

The ethylene polymers disclosed herein have a beneficial combination of stiffness, strength, and toughness (puncture or impact resistance) properties. For instance, the ethylene polymer can be characterized by a yield strength (ASTM D638 Tensile) ranging from 21 to 28 MPa, from 21 to 27 MPa, from 22 to 28 MPa, from 22 to 27 MPa, from 22 to 26 MPa, or from 23 to 27 MPa, and the like. Additionally or alternatively, these ethylene polymers can have an impact strength at −40° C. (ASTM D3763 High Speed Puncture, Joules) that ranges from 40 to 70 J, and more often, from 40 to 65 J, from 40 to 63 J, from 42 to 70 J, or from 42 to 65 J, although not limited thereto. Additionally or alternatively, these ethylene polymers can have a tangent modulus (flex modulus, ASTM D790 Flexural) in a range from 750 to 1200 MPa, such as from 750 to 1100 MPa, from 800 to 1200 MPa, from 800 to 1100 MPa, or from 850 to 1050 MPa, and the like. Additionally or alternatively, the ethylene polymer can have a 1% secant modulus (ASTM D638 Tensile) ranging from 650 to 1200 MPa. In certain aspects, the 1% secant modulus can fall within a range from 700 to 1100 MPa; alternatively, from 650 to 1050 MPa; alternatively, from 700 to 1000 MPa; or alternatively, from 725 to 975 MPa. The percent elongation at break (ASTM D638 Tensile) of these ethylene polymers is not particularly limited, but representative ranges include from 5 to 600%, from 10 to 500%, from 50 to 550%, from 50 to 450%, from 100 to 500%, from 200 to 450%, and the like.

A particular beneficial combination of these physical properties is a yield strength in a range from 21 to 28 MPa (or any other range disclosed herein), an impact strength at −40° C. in a range from 40 to 70 J (or any other range disclosed herein), and an environmental stress crack resistance (ESCR) of at least 5,000 hr (100% Igepal) and/or at least 2,500 hr (10% Igepal) (or any other range of the respective ESCR properties disclosed herein). Another particularly beneficial combination of these properties is a tangent modulus (flex modulus) in a range from 750 to 1200 MPa (or any other range disclosed herein), an impact strength at −40° C. in a range from 40 to 70 J (or any other range disclosed herein), and an environmental stress crack resistance (ESCR) of at least 5,000 hr (100% Igepal) and/or at least 2,500 hr (10% Igepal) (or any other range of the respective ESCR properties disclosed herein).

In an aspect, the ethylene polymers described herein can be a reactor product (e.g., a single reactor product), for example, not a post-reactor blend of two polymers, for instance, having different molecular weight characteristics. As one of skill in the art would readily recognize, physical blends of two different polymer resins can be made, but this necessitates additional processing and complexity not required for a reactor product.

Moreover, these ethylene polymers can be produced with dual metallocene catalyst systems containing zirconium and/or hafnium, discussed further below. Ziegler-Natta and chromium based catalysts systems are not required. Therefore, the ethylene polymer can contain no measurable amount of Mg, V, Ti, and/or Cr (catalyst residue), i.e., less than 0.1 ppm by weight. In some aspects, the first ethylene polymer, the second ethylene polymer, the third ethylene polymer, the fourth ethylene polymer, the fifth ethylene polymer, the sixth ethylene polymer, the seventh ethylene polymer, and the eighth ethylene polymer can contain less than 0.08 ppm, less than 0.05 ppm, or less than 0.03 ppm, independently, of Mg, V, Ti, and/or Cr.

### Articles and Products

Articles of manufacture can be formed from, and/or can comprise, the ethylene polymers of this invention and, accordingly, are encompassed herein. For example, articles which can comprise the polymers of this invention can include, but are not limited to, an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier, and the like. Various processes can be employed to form these articles. Non-limiting examples of these processes include injection molding, blow molding, rotational molding, film extrusion, sheet extrusion, profile extrusion, thermoforming, and the like.

Additionally, additives and modifiers often are added to these polymers in order to provide beneficial polymer processing or end-use product attributes. Such processes and materials are described in Modern Plastics Encyclopedia, Mid-November 1995 Issue, Vol. 72, No. 12; and Film Extrusion Manual—Process, Materials, Properties, TAPPI Press, 1992. In some aspects of this invention, an article of manufacture can comprise any of the ethylene polymers described herein, and the article of manufacture can be or can comprise an injected molded product, a rotational molded product, or an injection stretch blow molding product.

### Catalyst Compositions and Polymerization Processes

In accordance with aspects of the present invention, the ethylene polymer can be produced using a dual catalyst system. In these aspects, catalyst component I can comprise any suitable unbridged metallocene compound disclosed herein, and catalyst component II can comprise any suitable bridged metallocene compound disclosed herein. The catalyst system also can comprise any suitable activator or any activator disclosed herein, and optionally, any suitable co-catalyst or any co-catalyst disclosed herein.

Referring first to catalyst component I, which can comprise an unbridged zirconium or hafnium based metallocene compound containing two cyclopentadienyl groups, two indenyl groups, or a cyclopentadienyl and an indenyl group. In one aspect, catalyst component I can comprise an unbridged zirconium or hafnium based metallocene compound containing two cyclopentadienyl groups. In another aspect, catalyst component I can comprise an unbridged zirconium or hafnium based metallocene compound containing two indenyl groups. In yet another aspect, catalyst component I can comprise an unbridged zirconium or hafnium based metallocene compound containing a cyclopentadienyl group and an indenyl group.

Illustrative and non-limiting examples of unbridged metallocene compounds suitable for use as catalyst component I can include the following compounds (Ph=phenyl):

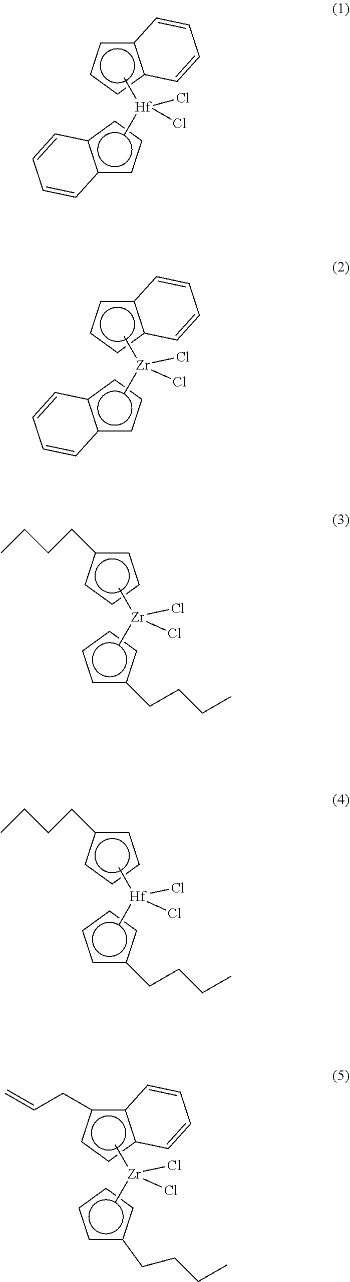

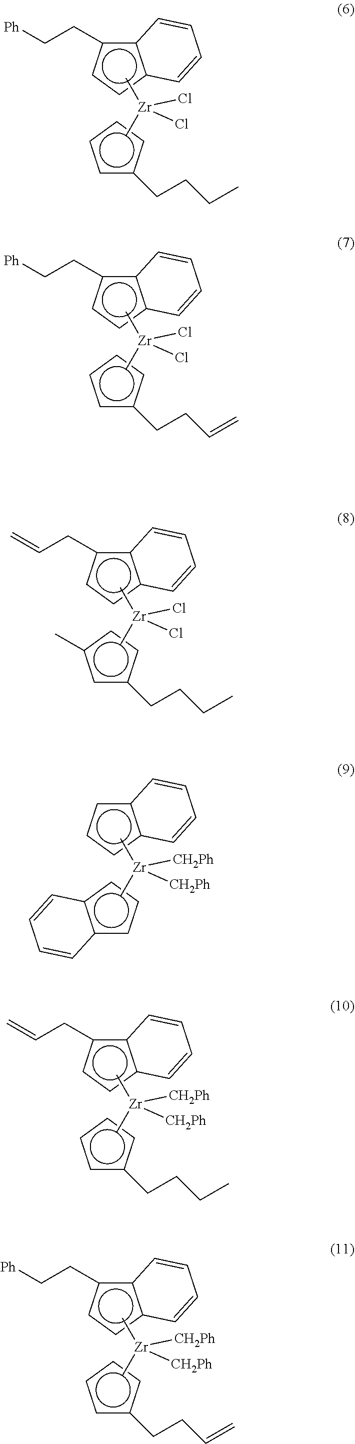

and the like, as well as combinations thereof.

Catalyst component I is not limited solely to unbridged metallocene compounds such as described above. Other suitable unbridged metallocene compounds are disclosed in U.S. Pat. Nos. 7,199,073, 7,226,886, 7,312,283, and 7,619,047.

Referring now to catalyst component II, which can be a bridged metallocene compound. In one aspect, for instance, catalyst component II can comprise a bridged zirconium or hafnium based metallocene compound. In another aspect, catalyst component II can comprise a bridged zirconium or hafnium based metallocene compound with an alkenyl substituent. In yet another aspect, catalyst component II can comprise a bridged zirconium or hafnium based metallocene compound with an alkenyl substituent and a fluorenyl group. In still another aspect, catalyst component II can comprise a bridged zirconium or hafnium based metallocene compound with a cyclopentadienyl group and a fluorenyl group, and with an alkenyl substituent on the bridging group and/or on the cyclopentadienyl group. Further, catalyst component II can comprise a bridged metallocene compound having an aryl group substituent on the bridging group.

Illustrative and non-limiting examples of bridged metallocene compounds suitable for use as catalyst component II can include the following compounds (Me=methyl, Ph=phenyl; t-Bu=tert-butyl):

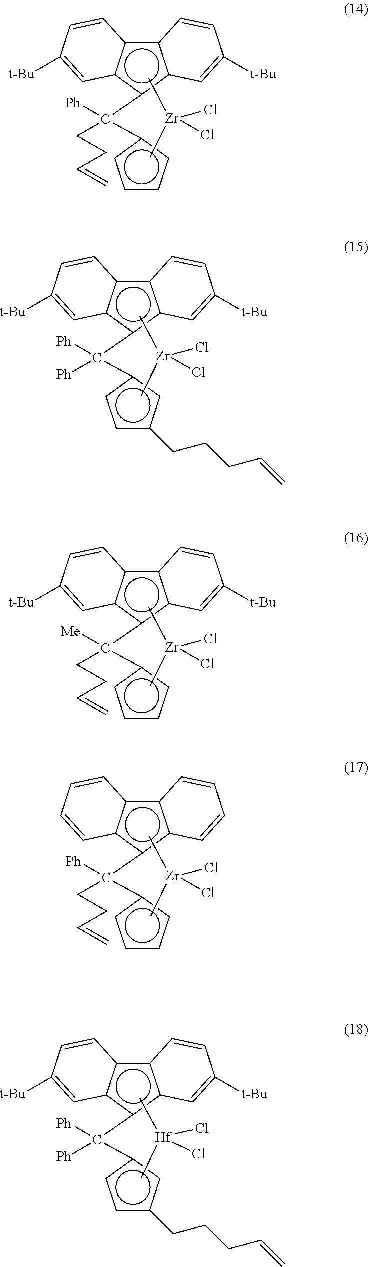

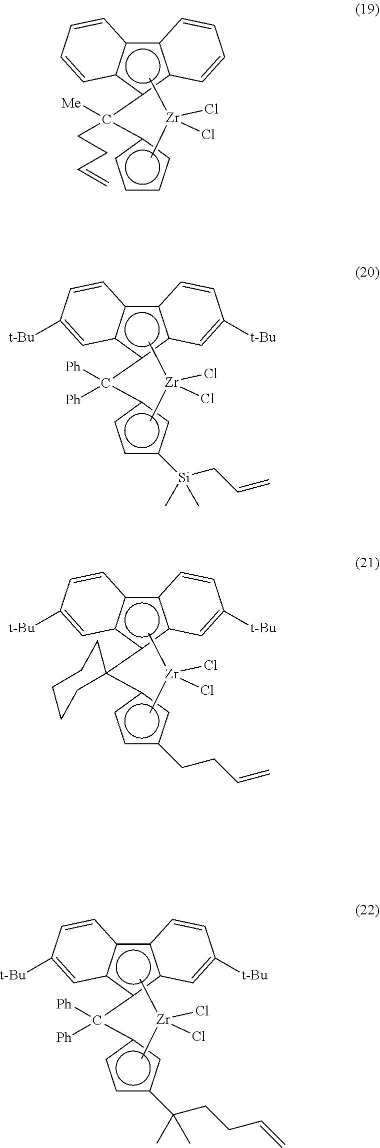

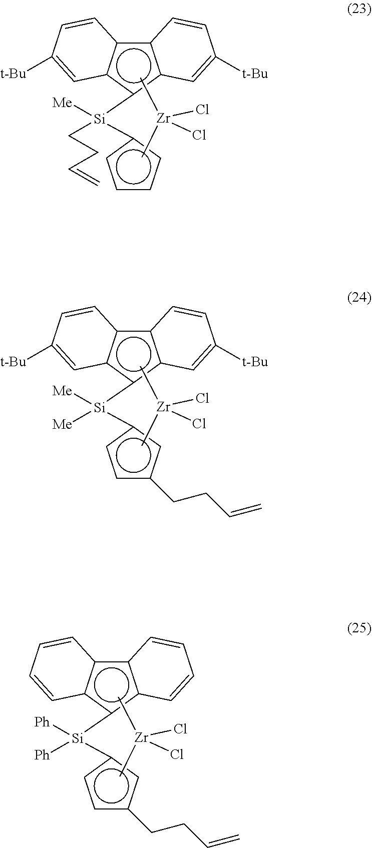

and the like, as well as combinations thereof.

Catalyst component II is not limited solely to the bridged metallocene compounds such as described above. Other suitable bridged metallocene compounds are disclosed in U.S. Pat. Nos. 7,026,494, 7,041,617, 7,226,886, 7,312,283, 7,517,939, and 7,619,047.

According to an aspect of this invention, the weight ratio of catalyst component I to catalyst component II in the catalyst composition can be in a range from 10:1 to 1:10, from 8:1 to 1:8, from 5:1 to 1:5, from 4:1 to 1:4, from 3:1 to 1:3; from 2:1 to 1:2, from 1.5:1 to 1:1.5, from 1.25:1 to 1:1.25, or from 1.1:1 to 1:1.1.

Additionally, the dual catalyst system contains an activator. For example, the catalyst system can contain an activator-support, an aluminoxane compound, an organoboron or organoborate compound, an ionizing ionic compound, and the like, or any combination thereof. The catalyst system can contain one or more than one activator.

In one aspect, the catalyst system can comprise an aluminoxane compound, an organoboron or organoborate compound, an ionizing ionic compound, and the like, or a combination thereof. Examples of such activators are disclosed in, for instance, U.S. Pat. Nos. 3,242,099, 4,794,096, 4,808,561, 5,576,259, 5,807,938, 5,919,983, and 8,114,946. In another aspect, the catalyst system can comprise an aluminoxane compound. In yet another aspect, the catalyst system can comprise an organoboron or organoborate compound. In still another aspect, the catalyst system can comprise an ionizing ionic compound.

In other aspects, the catalyst system can comprise an activator-support, for example, an activator-support comprising a solid oxide treated with an electron-withdrawing anion. Examples of such materials are disclosed in, for instance, U.S. Pat. Nos. 7,294,599, 7,601,665, 7,884,163, 8,309,485, 8,623,973, and 9,023,959. For instance, the activator-support can comprise fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided-chlorided silica-coated alumina, fluorided silica-coated alumina, sulfated silica-coated alumina, or phosphated silica-coated alumina, and the like, as well as any combination thereof. In some aspects, the activator-support can comprise a fluorided solid oxide and/or a sulfated solid oxide.

Various processes can be used to form activator-supports useful in the present invention. Methods of contacting the solid oxide with the electron-withdrawing component, suitable electron withdrawing components and addition amounts, impregnation with metals or metal ions (e.g., zinc, nickel, vanadium, titanium, silver, copper, gallium, tin, tungsten, molybdenum, zirconium, and the like, or combinations thereof), and various calcining procedures and conditions are disclosed in, for example, U.S. Pat. Nos. 6,107,230, 6,165,929, 6,294,494, 6,300,271, 6,316,553, 6,355,594, 6,376,415, 6,388,017, 6,391,816, 6,395,666, 6,524,987, 6,548,441, 6,548,442, 6,576,583, 6,613,712, 6,632,894, 6,667,274, 6,750,302, 7,294,599, 7,601,665, 7,884,163, and 8,309,485. Other suitable processes and procedures for preparing activator-supports (e.g., fluorided solid oxides and sulfated solid oxides) are well known to those of skill in the art.

The present invention can employ catalyst compositions containing catalyst component I, catalyst component II, an activator (one or more than one), and optionally, a co-catalyst. When present, the co-catalyst can include, but is not limited to, metal alkyl, or organometal, co-catalysts, with the metal encompassing boron, aluminum, zinc, and the like. Optionally, the catalyst systems provided herein can comprise a co-catalyst, or a combination of co-catalysts. For instance, alkyl boron, alkyl aluminum, and alkyl zinc compounds often can be used as co-catalysts in such catalyst systems. Representative boron compounds can include, but are not limited to, tri-n-butyl borane, tripropylborane, triethylborane, and the like, and this include combinations of two or more of these materials. While not being limited thereto, representative aluminum compounds (e.g., organoaluminum compounds) can include trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, and the like, as well as any combination thereof. Exemplary zinc compounds (e.g., organozinc compounds) that can be used as co-catalysts can include, but are not limited to, dimethylzinc, diethylzinc, dipropylzinc, dibutylzinc, dineopentylzinc, di(trimethylsilyl) zinc, di(triethylsilyl) zinc, di(triisoproplysilyl) zinc, di(triphenylsilyl) zinc, di(allyldimethylsilyl) zinc, di(trimethylsilylmethyl) zinc, and the like, or combinations thereof. Accordingly, in an aspect of this invention, the dual catalyst composition can comprise catalyst component I, catalyst component II, an activator-support, and an organoaluminum compound (and/or an organozinc compound).

In another aspect of the present invention, a catalyst composition is provided which comprises catalyst component I, catalyst component II, an activator-support, and an organoaluminum compound, wherein this catalyst composition is substantially free of aluminoxanes, organoboron or organoborate compounds, ionizing ionic compounds, and/or other similar materials; alternatively, substantially free of aluminoxanes; alternatively, substantially free or organoboron or organoborate compounds; or alternatively, substantially free of ionizing ionic compounds. In these aspects, the catalyst composition has catalyst activity in the absence of these additional materials. For example, a catalyst composition of the present invention can consist essentially of catalyst component I, catalyst component II, an activator-support, and an organoaluminum compound, wherein no other materials are present in the catalyst composition which would increase/decrease the activity of the catalyst composition by more than about 10% from the catalyst activity of the catalyst composition in the absence of said materials.

This invention further encompasses methods of making these catalyst compositions, such as, for example, contacting the respective catalyst components in any order or sequence. In one aspect, for example, the catalyst composition can be produced by a process comprising contacting, in any order, catalyst component I, catalyst component II, and the activator, while in another aspect, the catalyst composition can be produced by a process comprising contacting, in any order, catalyst component I, catalyst component II, the activator, and the co-catalyst.

Ethylene polymers can be produced from the disclosed catalyst systems using any suitable olefin polymerization process using various types of polymerization reactors, polymerization reactor systems, and polymerization reaction conditions. One such olefin polymerization process for polymerizing olefins in the presence of a catalyst composition of the present invention can comprise contacting the catalyst composition with ethylene and optionally an olefin comonomer (one or more) in a polymerization reactor system under polymerization conditions to produce an ethylene polymer, wherein the catalyst composition can comprise, as disclosed herein, catalyst component I, catalyst component II, an activator, and an optional co-catalyst. This invention also encompasses any ethylene polymers (e.g., ethylene copolymers) produced by any of the polymerization processes disclosed herein.

As used herein, a “polymerization reactor” includes any polymerization reactor capable of polymerizing olefin monomers and comonomers (one or more than one comonomer) to produce homopolymers, copolymers, terpolymers, and the like. The various types of polymerization reactors include those that can be referred to as a batch reactor, slurry reactor, gas-phase reactor, solution reactor, high pressure reactor, tubular reactor, autoclave reactor, and the like, or combinations thereof; or alternatively, the polymerization reactor system can comprise a slurry reactor, a gas-phase reactor, a solution reactor, or a combination thereof. The polymerization conditions for the various reactor types are well known to those of skill in the art. Gas phase reactors can comprise fluidized bed reactors or staged horizontal reactors. Slurry reactors can comprise vertical or horizontal loops. High pressure reactors can comprise autoclave or tubular reactors. Reactor types can include batch or continuous processes. Continuous processes can use intermittent or continuous product discharge. Polymerization reactor systems and processes also can include partial or full direct recycle of unreacted monomer, unreacted comonomer, and/or diluent.

A polymerization reactor system can comprise a single reactor or multiple reactors (2 reactors, more than 2 reactors) of the same or different type. For instance, the polymerization reactor system can comprise a slurry reactor, a gas-phase reactor, a solution reactor, or a combination of two or more of these reactors. Production of polymers in multiple reactors can include several stages in at least two separate polymerization reactors interconnected by a transfer device making it possible to transfer the polymers resulting from the first polymerization reactor into the second reactor. The desired polymerization conditions in one of the reactors can be different from the operating conditions of the other reactor(s). Alternatively, polymerization in multiple reactors can include the manual transfer of polymer from one reactor to subsequent reactors for continued polymerization. Multiple reactor systems can include any combination including, but not limited to, multiple loop reactors, multiple gas phase reactors, a combination of loop and gas phase reactors, multiple high pressure reactors, or a combination of high pressure with loop and/or gas phase reactors. The multiple reactors can be operated in series, in parallel, or both. Accordingly, the present invention encompasses polymerization reactor systems comprising a single reactor, comprising two reactors, and comprising more than two reactors. The polymerization reactor system can comprise a slurry reactor, a gas-phase reactor, a solution reactor, in certain aspects of this invention, as well as multi-reactor combinations thereof.

According to one aspect, the polymerization reactor system can comprise at least one loop slurry reactor comprising vertical or horizontal loops. Monomer, diluent, catalyst, and comonomer can be continuously fed to a loop reactor where polymerization occurs. Generally, continuous processes can comprise the continuous introduction of monomer/comonomer, a catalyst, and a diluent into a polymerization reactor and the continuous removal from this reactor of a suspension comprising polymer particles and the diluent. Reactor effluent can be flashed to remove the solid polymer from the liquids that comprise the diluent, monomer and/or comonomer. Various technologies can be used for this separation step including, but not limited to, flashing that can include any combination of heat addition and pressure reduction, separation by cyclonic action in either a cyclone or hydrocyclone, or separation by centrifugation. A typical slurry polymerization process (also known as the particle form process) is disclosed, for example, in U.S. Pat. Nos. 3,248,179, 4,501,885, 5,565,175, 5,575,979, 6,239,235, 6,262,191, 6,833,415, and 8,822,608. Suitable diluents used in slurry polymerization include, but are not limited to, the monomer being polymerized and hydrocarbons that are liquids under reaction conditions. Examples of suitable diluents include, but are not limited to, hydrocarbons such as propane, cyclohexane, isobutane, n-butane, n-pentane, isopentane, neopentane, and n-hexane. Some loop polymerization reactions can occur under bulk conditions where no diluent is used.

According to yet another aspect, the polymerization reactor system can comprise at least one gas phase reactor (e.g., a fluidized bed reactor). Such reactor systems can employ a continuous recycle stream containing one or more monomers continuously cycled through a fluidized bed in the presence of the catalyst under polymerization conditions. A recycle stream can be withdrawn from the fluidized bed and recycled back into the reactor. Simultaneously, polymer product can be withdrawn from the reactor and new or fresh monomer can be added to replace the polymerized monomer. Such gas phase reactors can comprise a process for multi-step gas-phase polymerization of olefins, in which olefins are polymerized in the gaseous phase in at least two independent gas-phase polymerization zones while feeding a catalyst-containing polymer formed in a first polymerization zone to a second polymerization zone. Representative gas phase reactors are disclosed in U.S. Pat. Nos. 5,352,749, 4,588,790, 5,436,304, 7,531,606, and 7,598,327.

According to still another aspect, the polymerization reactor system can comprise a high pressure polymerization reactor, e.g., can comprise a tubular reactor or an autoclave reactor. Tubular reactors can have several zones where fresh monomer, initiators, or catalysts are added. Monomer can be entrained in an inert gaseous stream and introduced at one zone of the reactor. Initiators, catalysts, and/or catalyst components can be entrained in a gaseous stream and introduced at another zone of the reactor. The gas streams can be intermixed for polymerization. Heat and pressure can be employed appropriately to obtain optimal polymerization reaction conditions.

According to yet another aspect, the polymerization reactor system can comprise a solution polymerization reactor wherein the monomer/comonomer are contacted with the catalyst composition by suitable stirring or other means. A carrier comprising an inert organic diluent or excess monomer can be employed. If desired, the monomer/comonomer can be brought in the vapor phase into contact with the catalytic reaction product, in the presence or absence of liquid material. The polymerization zone can be maintained at temperatures and pressures that will result in the formation of a solution of the polymer in a reaction medium. Agitation can be employed to obtain better temperature control and to maintain uniform polymerization mixtures throughout the polymerization zone. Adequate means are utilized for dissipating the exothermic heat of polymerization.

The polymerization reactor system can further comprise any combination of at least one raw material feed system, at least one feed system for catalyst or catalyst components, and/or at least one polymer recovery system. Suitable reactor systems can further comprise systems for feedstock purification, catalyst storage and preparation, extrusion, reactor cooling, polymer recovery, fractionation, recycle, storage, loadout, laboratory analysis, and process control. Depending upon the desired properties of the olefin polymer, hydrogen can be added to the polymerization reactor as needed (e.g., continuously or pulsed).

Polymerization conditions that can be controlled for efficiency and to provide desired polymer properties can include temperature, pressure, and the concentrations of various reactants. Polymerization temperature can affect catalyst productivity, polymer molecular weight, and molecular weight distribution. Various polymerization conditions can be held substantially constant, for example, for the production of a particular grade of the olefin polymer (or ethylene polymer). A suitable polymerization temperature can be any temperature below the de-polymerization temperature according to the Gibbs Free energy equation. Typically, this includes from 60° C. to 280° C., for example, or from 60° C. to 120° C., depending upon the type of polymerization reactor(s). In some reactor systems, the polymerization temperature generally can be within a range from 70° C. to 105° C., or from 75° C. to 100° C.

Suitable pressures will also vary according to the reactor and polymerization type. The pressure for liquid phase polymerizations in a loop reactor is typically less than 1000 psig (6.9 MPa). Pressure for gas phase polymerization is usually from 200 to 500 psig (1.4 MPa to 3.4 MPa). High pressure polymerization in tubular or autoclave reactors is generally run at from 20,000 to 75,000 psig (138 to 517 MPa). Polymerization reactors can also be operated in a supercritical region occurring at generally higher temperatures and pressures. Operation above the critical point of a pressure/temperature diagram (supercritical phase) can offer advantages to the polymerization reaction process.

When a copolymer is desired, ethylene can be copolymerized with a comonomer (e.g., a C₂-C₂₀ alpha-olefin or a C₃-C₂₀ alpha-olefin). According to one aspect of this invention, the comonomer can comprise a C₃-C₁₀ alpha-olefin; alternatively, the comonomer can comprise 1-butene, 1-pentene, 1-hexene, 1-octene, 1-decene, styrene, or any combination thereof; alternatively, the comonomer can comprise 1-butene, 1-hexene, 1-octene, or any combination thereof; alternatively, the comonomer can comprise 1-butene; alternatively, the comonomer can comprise 1-hexene; or alternatively, the comonomer can comprise 1-octene.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Melt index (MI, g/10 min) was determined in accordance with ASTM D1238 at 190° C. with a 2,160 gram weight, and high load melt index (HLMI, g/10 min) was determined in accordance with ASTM D1238 at 190° C. with a 21,600 gram weight. Density was determined in grams per cubic centimeter (g/cm³) on a compression molded sample, cooled at 15° C. per minute, and conditioned for 40 hours at room temperature in accordance with ASTM D1505 and ASTM D4703. Environmental stress crack resistance (ESCR) was determined in accordance with ASTM D1693, condition A, with 10% Igepal or 100% Igepal as specified. The measured time to failure (hr) is the result of the ESCR test.

Molecular weights and molecular weight distributions were obtained using a PL-GPC 220 (Polymer Labs, an Agilent Company) system equipped with a IR4 detector (Polymer Char, Spain) and three Styragel HMW-6E GPC columns (Waters, MA) running at 145° C. The flow rate of the mobile phase 1,2,4-trichlorobenzene (TCB) containing 0.5 g/L 2,6-di-t-butyl-4-methylphenol (BHT) was set at 1 m/min, and polymer solution concentrations were in the range of 1.0-1.5 mg/mL, depending on the molecular weight. Sample preparation was conducted at 150° C. for nominally 4 hr with occasional and gentle agitation, before the solutions were transferred to sample vials for injection. An injection volume of about 400 μL was used. The integral calibration method was used to deduce molecular weights and molecular weight distributions using a Chevron Phillips Chemical Company's HDPE polyethylene resin, MARLEX® BHB5003, as the broad standard. An integral table of the broad standard was pre-determined in a separate experiment with SEC-MALS. Mn is the number-average molecular weight, Mw is the weight-average molecular weight, Mz is the z-average molecular weight, Mv is the viscosity-average molecular weight, and Mp is the peak molecular weight (location, in molecular weight, of the highest point of the molecular weight distribution curve). The IB parameter was determined from the molecular weight distribution curve (plot of dW/d(Log M) vs. Log M; normalized to an area equal to 1), and is defined as 1/[dW/d(Log M)]_{MAX}. IVc is the intrinsic viscosity [η], which is calculated based on Equation 1:

[η]=KMv^{a} Eq. 1.

In Equation 1, Mv is the viscosity-average molecular weight, K and a are Mark-Houwink constants for the polymer of interest. For polyethylene, K and a are 3.95E-04 (dL/g) and 0.726 (unitless), respectively. Mv is calculated based on Equation 2, where wᵢ and Mᵢ are weight fraction and molecular weight of slice i, respectively:

$${M}_{V} = {[ \frac{\sum {w}_{i} {M}_{i}^{a}}{\sum {w}_{i}} ]}^{1 / a} . \qquad Eq . 2$$

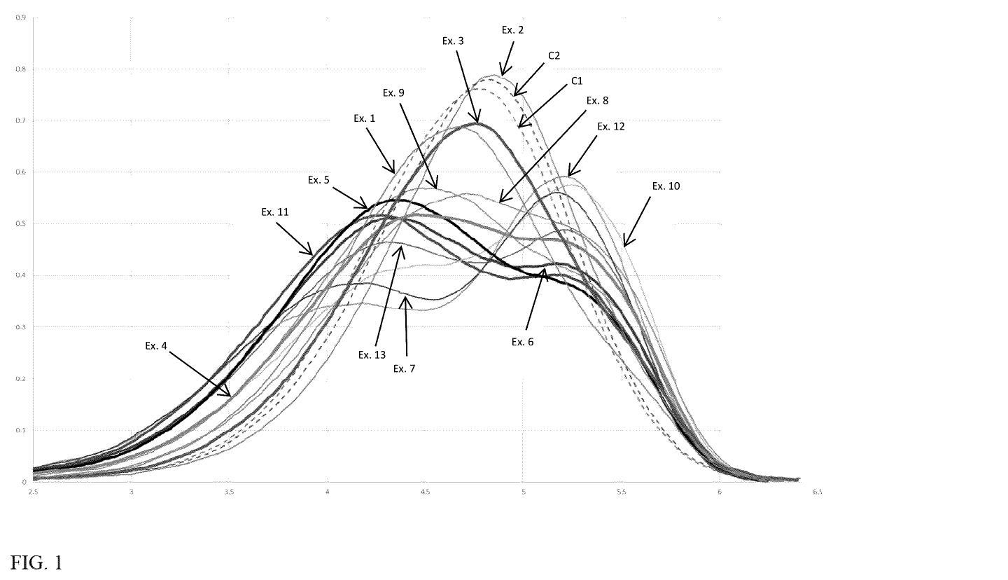

The respective LMW component and HMW component properties were determined by deconvoluting the molecular weight distribution (see e.g., FIG. 1) of each polymer. The relative amounts of the LMW and HMW components (weight percentages) in the polymer were determined using an Excel based spreadsheet program fitting 5 Shultz-Flory Distributions (SFDs) to each component (5 for the LMW and 5 for the HMW). The LMW and HMW could then be fractioned to fit the overall MWD, providing the deconvolution. Fitting to both the MWD and short chain branching distribution was completed. Properties for the each of the LMW and HMW components were then calculated.

Melt rheological characterizations were performed as follows. Small-strain (less than 10%) oscillatory shear measurements were performed on an Anton Paar MCR rheometer using parallel-plate geometry. All rheological tests were performed at 190° C. The complex viscosity |η*| versus frequency (co) data were then curve fitted using the modified three parameter Carreau-Yasuda (CY) empirical model to obtain the zero shear viscosity—η₀, characteristic viscous relaxation time—τ_{η}, and the breadth parameter—a (CY-a parameter). The simplified Carreau-Yasuda (CY) empirical model is shown in Equation 3:

$$\vert η * ( ω ) \vert = \frac{{η}_{0}}{{[ 1 + {( {τ}_{η} ω )}^{a} ]}^{( 1 - n ) / a}} , \qquad Eq . 3$$

wherein:
   |η*(ω)|=magnitude of complex shear viscosity;
η₀=zero shear viscosity;
τₙ=viscous relaxation time (Tau(f));
a=“breadth” parameter (CY-a parameter);
n=fixes the final power law slope, fixed at 2/11; and
ω=angular frequency of oscillatory shearing deformation.

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong, and O. Hasseger, Dynamics of Polymeric Liquids, Volume 1, Fluid Mechanics, 2nd Edition, John Wiley & Sons (1987). The tan δ at 0.1 sec⁻¹, tan δ at 100 sec⁻¹, viscosity at 0.1 sec⁻¹, viscosity at 100 sec⁻¹, and viscosity at HLMI (viscosity at the HLMI stress for the polymer at its HLMI) properties were determined using the Carreau-Yasuda (CY) empirical model.

Short chain branch content and short chain branching distribution (SCBD) across the molecular weight distribution were determined via an IR5-detected GPC system (IR5-GPC) using the method established by Yu (Y. Yu, Macromolecular Symposium, 2020, 390, 1900014), wherein the GPC system was a PL220 GPC/SEC system (Polymer Labs, an Agilent company) equipped with three Styragel HMW-6E columns (Waters, MA) for polymer separation. A thermoelectric-cooled IR5 MCT detector (IR5) (Polymer Characterisation SA, Spain) was connected to the GPC columns via a hot-transfer line. Chromatographic data was obtained from two output ports of the IR5 detector. First, the analog signal goes from the analog output port to a digitizer before connecting to Computer “A” for molecular weight determinations via the Cirrus software (Polymer Labs, now an Agilent Company) and the integral calibration method using a HDPE Marlex™ BHB5003 resin (Chevron Phillips Chemical) as the molecular weight standard. The digital signals, on the other hand, go via a USB cable directly to Computer “B” where they are collected by a GPC/SEC data collection software provided by Agilent Technologies. Chromatographic conditions were set as follows: column oven temperature of 145° C.; flowrate of 1 mL/min; injection volume of 0.4 mL; and polymer concentration of about 2 mg/mL, depending on sample molecular weight. The temperatures for both the hot-transfer line and IR5 detector sample cell were set at 150° C., while the temperature of the electronics of the IR5 detector was set at 60° C. Short chain branching content was determined via an in-house method using the intensity ratio of CH₃ (I_{CH3}) to CH₂ (I_{CH2}) coupled with a calibration curve. The calibration curve was a plot of SCB content (x_{SCB}) as a function of the intensity ratio of I_{CH3}/I_{CH2}. To obtain a calibration curve, a group of polyethylene resins (no less than 5) of SCB level ranging from zero to ca. 32 SCB/1,000 total carbons (SCB Standards) were used. All these SCB Standards have known SCB levels and flat SCBD profiles pre-determined separately by NMR and the solvent-gradient fractionation coupled with NMR (SGF-NMR) methods. Using SCB calibration curves thus established, profiles of short chain branching distribution across the molecular weight distribution were obtained for resins fractionated by the IR5-GPC system under exactly the same chromatographic conditions as for these SCB standards. A relationship between the intensity ratio and the elution volume was converted into SCB distribution as a function of MWD using a predetermined SCB calibration curve (i.e., intensity ratio of I_{CH3}/I_{CH2} vs. SCB content) and MW calibration curve (i.e., molecular weight vs. elution time) to convert the intensity ratio of I_{CH3}/I_{CH2} and the elution time into SCB content and the molecular weight, respectively.

The ATREF procedure was as follows. Forty mg of the polymer sample and 20 mL of 1,2,4-trichlorobenzene (TCB) were sequentially charged into a vessel on a PolyChar TREF 200+ instrument. After dissolving the polymer, an aliquot (500 microliters) of the polymer solution was loaded on the column (stainless steel shots) at 150° C., cooled at 10° C./min to 110° C., stabilized at 110° C. for 10 min, then cooled at 0.5° C./min to 25° C. Then, the elution was begun with a 0.5 mL/min TCB flow rate and heating at 1° C./min up to 120° C., and analyzing with an IR detector. The peak ATREF temperature is the location, in temperature, of the highest point of the ATREF curve (profile).

The long chain branches (LCBs) per 1,000,000 total carbon atoms of the overall polymer were calculated using the method of Janzen and Colby (J. Mol. Struct., 485/486, 569-584 (1999)), from values of zero shear viscosity, ηₒ (determined from the Carreau-Yasuda model, described hereinabove), and measured values of Mw obtained using GPC discussed above.

Calculated values of the primary structure parameters PSP4 and PSP2 were determined as described in Polymer 147 (2018) 8-19; Polymer 153 (2018) 422-429; Polymer 180 (2019) 121730; and U.S. Pat. No. 8,492,498.

Tensile properties, such as yield strength, elongation at break, and 1% secant modulus were determined in accordance with ASTM D638. Tangent modulus or flexural modulus was determined in accordance with ASTM D790. Impact resistance at different temperatures was determined in accordance with ASTM D3763 high speed puncture test. Strain hardening modulus (SHM) was determined in accordance with ISO 18488.

Metals content, such as the amount of catalyst residue in the ethylene polymer or article, can be determined by ICP analysis on a PerkinElmer Optima 8300 instrument. Polymer samples can be ashed in a Thermolyne furnace with sulfuric acid overnight, followed by acid digestion in a HotBlock with HCl and HNO₃ (3:1 v:v).

### Examples 1-24

Comparative Examples C1-C4 were ethylene/1-hexene copolymers produced using a Ziegler-Natta catalyst in a gas phase process. Examples 1-24 were prepared as follows in a pilot scale loop slurry reactor. Pilot plant polymerizations were conducted in a 30-gallon slurry loop reactor at a production rate of approximately 30-33 lb of polymer per hr. Polymerization work was carried out under continuous particle form process conditions in a loop reactor (also referred to as a slurry process) by contacting a dual metallocene solution (containing MET1 and MET2) in toluene and isobutane, an organoaluminum solution (triisobutylaluminum, TIBA), and an activator-support (fluorided silica-coated alumina, ˜7 wt. % F) in a 1-L stirred autoclave with continuous output to the loop reactor. The TIBA and dual metallocene solution were fed as separate streams into the isobutane flush. The activator-support was flushed with isobutane and the TIBA/metallocene mixture flowing together to the autoclave. The isobutane flush used to transport the activator-support into the autoclave was set at a rate that would result in a residence time of approximately 30 min in the autoclave. The total flow from the autoclave then entered the loop reactor.

Ethylene used was polymerization grade ethylene obtained from AirGas or Praxair which was purified through a column of alumina-zeolite adsorbent (activated at 230-290° C. in nitrogen). Polymerization grade 1-hexene (obtained from Chevron Phillips Chemical Company) which was purified by distillation and passed through a column of alumina-zeolite absorbent activated at 230-290° C. in nitrogen. The loop reactor was liquid full, 15.2 cm diameter, having a volume of 30 gallons (113.6 L). Liquid isobutane was used as the diluent. Hydrogen was added to tune the molecular weight and/or HLMI of the polymer product. The isobutane was polymerization grade isobutane (obtained from Enterprise) that was further purified by distillation and subsequently passed through a column of alumina (activated at 230-290° C. in nitrogen). Co-catalyst TIBA was added in a concentration in a range of 75 to 130 ppm based on the weight of the diluent in the polymerization reactor.

Reactor conditions included a reactor pressure from 550 to 600 psig, a mol % ethylene of 11 to 13% (based on isobutane diluent), a 1-hexene content of 0.05 to 0.9 mol % (based on isobutane diluent), and a polymerization temperature of 97-100° C. The reactor was operated to have a residence time of about 0.8-1.35 hr. Total metallocene concentrations in the reactor were within a range of about 1.2 to 3.5 parts per million (ppm) by weight of the diluent. The activator-support (fluorided silica-coated alumina) was fed to the reactor at the rate of approximately 0.015-0.038 lb per hr. Table 1 summarizes the relative amounts of MET1 and MET2 in the catalyst system (molar ratio of MET1 and MET2) for Examples 1-24, as well as the hydrogen:ethylene weight ratio in the reactor feed. Polymer was removed from the reactor at the rate of about 30-33 lb/hr and passed through a flash chamber and a purge column. Nitrogen was fed to the purge column to ensure the fluff was hydrocarbon free. The structures for MET1 (unbridged) and MET2 (bridged), used in Examples 1-24, are shown below:

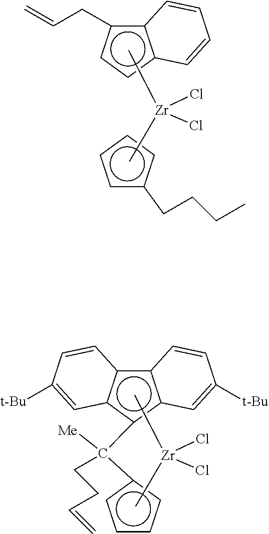

Tables 2-11 summarizes the polymer properties of Examples 1-24 and Comparative Examples C1-C4. As shown in Table 2, the ESCR performance of the polymers of Examples 1-24 was superior, by orders of magnitude, over the polymers of Comparative Examples C1-C4. Particularly noteworthy are the polymers of Examples 4-16 and 19-24, which had ESCR values of greater than 7,000 hr (100% Igepal), and in some cases, greater than 10,000 hr. The polymers of Examples 1-17 and 19-24 had melt indexes of 0.9-6 g/10 min, ratios of HLMI/MI of 30-70, densities of 0.948-0.956 g/cm³, ratios of Mw/Mn of 5-16, and Mz values of 260-390 kg/mol, as reflected in Tables 2-3. FIG. 1 illustrates the molecular weight distributions (amount of polymer versus the logarithm of molecular weight) of the polymers of Examples 1-13 and Comparative Examples C1-C2. Tables 4-5 summarize the deconvoluted molecular weight data and respective molecular weight and SCB parameters for the LMW and HMW components of the polymers of Examples 1-24.

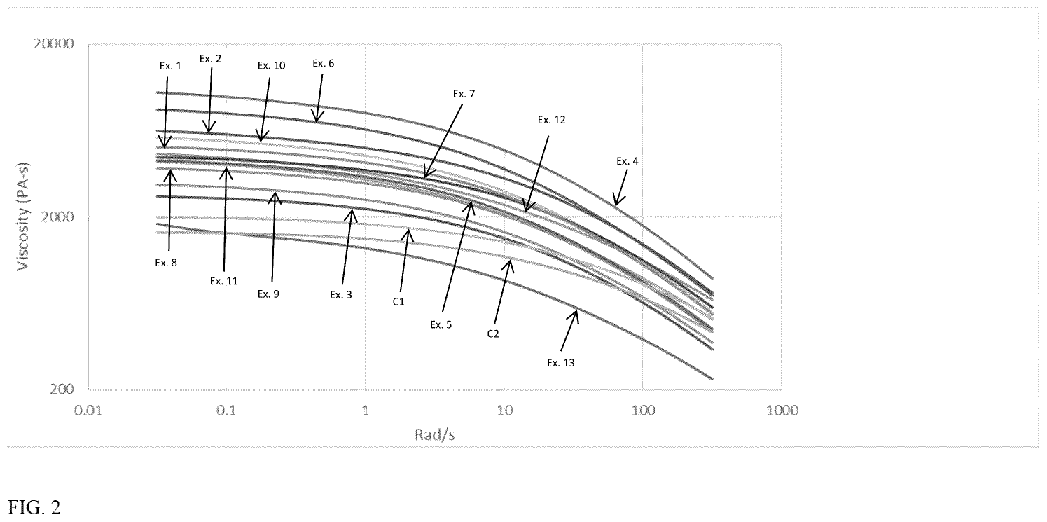

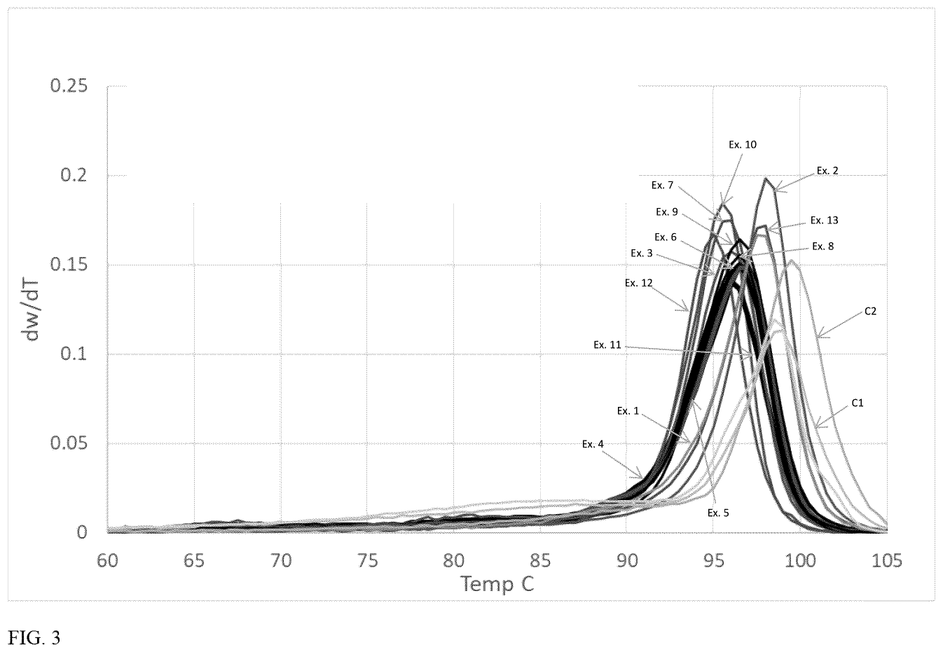

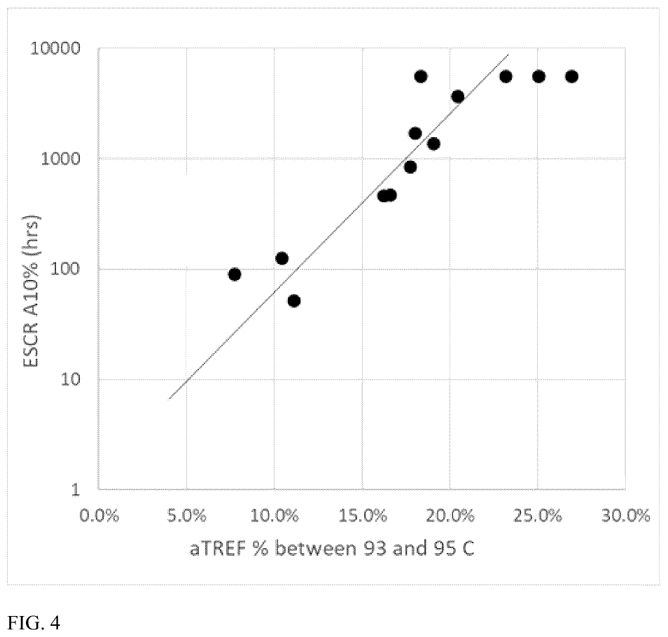

Rheological properties are summarized in Tables 6-7, and FIG. 2 is a dynamic rheology plot at 190° C. for the polymers of Examples 1-13 and Comparative Examples C1-C2. Generally, the polymers of Examples 1-24 had much lower tan d @ 0.1 sec⁻¹, much lower tan d @ 100 sec⁻¹, and much higher ratios of the viscosity at 0.1 sec⁻¹ to 100 sec⁻¹, versus the polymers of Comparative Examples C1-C4. The SCB, LCB, and ATREF properties are tabulated in Tables 8-9. From these tables, the polymers of Examples 1-24 had much higher amounts of SCB in the high molecular weight fraction of the polymer (SCB @ Mz divided by SCB @ Mn), higher LCB contents, and significantly more polymer elution in the 93-95° C. range, versus the polymers of Comparative Examples C1-C4. FIG. 3 illustrates the ATREF profiles of the polymers of Examples 1-13 and Comparative Examples C1-C2, while FIG. 4 demonstrates the correlation between ESCR (condition A, 10% Igepal) and the percentage of polymer eluted in the 93-95° C. range in an ATREF test for the polymers of Examples 1-13.

Tensile, Flex, and (room temperature and cold temperature) Impact properties are summarized in Tables 10-11. The polymer of Comparative Example C1 had lower stiffness (yield, tensile modulus, tangent modulus, secant modulus) and higher impact strength at −40° C., whereas the polymer of Comparative Example C2 had higher stiffness (yield, tensile modulus, tangent modulus, secant modulus) and lower impact strength at −40° C. Unexpectedly, the polymers of Examples 1-24 had the beneficial combination of both high stiffness (yield, tensile modulus, tangent modulus, secant modulus) and high impact strength at −40° C. (generally, in the 40-63 J range). In combination with the aforementioned ESCR properties, various molded containers (e.g., pails and containers for soaps, paints, chemicals, and the like) made from the polymers of Examples 1-24 can be downgauged with superior performance due to the higher stiffness, without sacrificing excellent impact strength and outstanding stress crack resistance (ESCR).

TABLE 1

| | | lb H₂/1000 |
|---|---|---|
| Example | MET1:MET2 | lb C₂H4 |
| 1 | 7.8 | 0.18 |
| 2 | 7.8 | 0.09 |
| 3 | 7.0 | 0.13 |
| 4 | 5.4 | 0.21 |
| 5 | 7.0 | 0.30 |
| 6 | 6.6 | 0.30 |
| 7 | 5.5 | 0.42 |
| 8 | 5.5 | 0.14 |
| 9 | 6.8 | 0.21 |
| 10 | 4.3 | 0.21 |
| 11 | 6.8 | 0.37 |
| 12 | 4.3 | 0.37 |
| 13 | 5.5 | 0.30 |
| 14 | 7.7 | 0.24 |
| 15 | 7.5 | 0.34 |
| 16 | 6.7 | 0.14 |
| 17 | 8.0 | 0.14 |
| 18 | 8.5 | 0.34 |
| 19 | 7.7 | 0.24 |
| 20 | 6.9 | 0.24 |
| 21 | 6.8 | 0.33 |
| 22 | 8.2 | 0.24 |
| 23 | 7.4 | 0.33 |
| 24 | 7.0 | 0.24 |

TABLE 2
Polymer Properties

| | MI | HLMI | | | ESCR, | ESCR, | | | |
|---|---|---|---|---|---|---|---|---|---|
| | (g/10 | (g/10 | HLMI/ | Density | A, 100% | A, 10% | SHM | | |
| Example | min) | min) | MI | (g/cc) | (hr) | (hr) | (MPa) | PSP4 | PSP2 |
| 1 | 5.40 | 217 | 40.2 | 0.954 | 432 | 52 | 20.9 | 0.32 | 5.65 |
| 2 | 2.23 | 67 | 30.2 | 0.950 | 1502 | 91 | 24.4 | 0.30 | 7.46 |
| 3 | 2.84 | 108 | 38.0 | 0.951 | 4279 | 127 | 26.8 | 0.33 | 6.86 |
| 4 | 1.84 | 87 | 47.3 | 0.951 | >10575 | 1716 | 35.8 | 0.49 | 7.61 |
| 5 | 4.27 | 282 | 66.0 | 0.955 | >10575 | 470 | 24.3 | 0.41 | 6.10 |
| 6 | 3.12 | 178 | 57.1 | 0.954 | >10575 | 846 | 28.0 | 0.50 | 6.88 |
| 7 | 2.31 | 82 | 35.5 | 0.951 | >10575 | 7738 | 32.1 | 0.63 | 8.04 |
| 8 | 1.22 | 49 | 40.2 | 0.949 | >10575 | >10575 | 42.3 | 0.61 | 8.71 |
| 9 | 2.69 | 137 | 50.9 | 0.953 | >10575 | 465 | 30.8 | 0.50 | 6.99 |
| 10 | 0.96 | 31 | 32.3 | 0.948 | >10575 | >10575 | 46.2 | 0.69 | 9.65 |
| 11 | 3.92 | 247 | 63.0 | 0.955 | >10575 | 1380 | 26.1 | 0.53 | 6.43 |
| 12 | 1.63 | 52 | 31.9 | 0.949 | >10575 | >10575 | 37.8 | 0.65 | 8.63 |
| 13 | 2.00 | 92 | 46.0 | 0.952 | >10575 | 4292 | 37.7 | 0.49 | 6.37 |
| 14 | 3.02 | 148 | 49.0 | 0.949 | >7000 | 3035 | 38.2 | 0.76 | 7.68 |
| 15 | 4.97 | 282 | 56.7 | 0.952 | >7000 | 2181 | 32.0 | 0.68 | 6.71 |
| 16 | 1.72 | 65 | 37.9 | 0.946 | >7000 | >7000 | 46.9 | 0.83 | 9.02 |
| 17 | 5.73 | 221 | 38.6 | 0.950 | >4504 | 96 | 26.6 | 0.55 | 6.49 |
| 18 | 14.80 | 863 | 58.3 | 0.955 | — | — | 18.9 | 0.51 | 4.71 |
| 19 | 3.64 | 194 | 53.3 | 0.949 | >7000 | 1509 | 35.7 | 0.69 | 7.25 |
| 20 | 4.29 | 222 | 51.7 | 0.950 | >7000 | 1630 | 33.6 | 0.75 | 7.13 |
| 21 | 5.33 | 225 | 42.2 | 0.950 | >7000 | 2074 | 32.5 | 0.73 | 7.17 |
| 22 | 3.98 | 189 | 47.5 | 0.949 | >7000 | 3534 | 35.3 | 0.78 | 7.38 |
| 23 | 3.87 | 220 | 56.8 | 0.953 | >7000 | >7000 | 29.5 | 0.51 | 6.78 |
| 24 | 3.68 | 184 | 50.0 | 0.949 | >7000 | 1388 | 33.8 | 0.78 | 7.41 |
| C1 | 5.75 | 160 | 27.9 | 0.945 | 96 | 24 | — | 0.83 | 7.55 |
| C2 | 5.08 | 116 | 22.8 | 0.953 | 28 | 24 | — | 0.12 | 5.74 |
| C3 | 6.00 | 160 | 26.7 | 0.944 | 74 | 24 | 17.9 | — | — |
| C4 | 3.69 | 96 | 26.1 | 0.952 | 50 | 28 | 14.5 | — | — |

TABLE 3
Molecular Weight Characterization (molecular weights in kg/mol)

| Example | Mn | Mw | Mz | Mw/Mn | Mz/Mw | IB | IVc |
|---|---|---|---|---|---|---|---|
| 1 | 13.1 | 91.9 | 323.4 | 7.00 | 3.52 | 1.45 | 2.40 |
| 2 | 21.1 | 113.2 | 326.4 | 5.37 | 2.88 | 1.27 | 2.43 |
| 3 | 15.7 | 109.4 | 378.3 | 6.96 | 3.46 | 1.44 | 2.68 |
| 4 | 10.1 | 111.7 | 362.3 | 11.08 | 3.24 | 1.93 | 2.66 |
| 5 | 8.0 | 91.5 | 331.4 | 11.49 | 3.62 | 1.83 | 2.49 |
| 6 | 7.9 | 97.6 | 339.2 | 12.38 | 3.48 | 1.96 | 2.54 |
| 7 | 6.7 | 106.4 | 315.2 | 15.95 | 2.96 | 1.79 | 2.43 |
| 8 | 13.9 | 126.4 | 387.6 | 9.12 | 3.07 | 1.79 | 2.79 |
| 9 | 10.7 | 103.5 | 360.1 | 9.64 | 3.48 | 1.76 | 2.63 |
| 10 | 10.4 | 131.7 | 385.4 | 12.68 | 2.93 | 1.74 | 2.79 |
| 11 | 7.4 | 90.1 | 326.4 | 12.17 | 3.62 | 1.94 | 2.47 |
| 12 | 7.3 | 117.1 | 355.9 | 15.95 | 3.04 | 1.69 | 2.63 |
| 13 | 8.4 | 108.4 | 347.5 | 12.97 | 3.21 | 2.05 | 2.59 |
| 14 | 8.2 | 93.1 | 300.0 | 11.29 | 3.22 | 1.92 | 2.31 |
| 15 | 6.0 | 81.5 | 281.6 | 13.70 | 3.45 | 1.95 | 2.21 |
| 16 | 13.2 | 108.6 | 310.2 | 8.26 | 2.86 | 1.79 | 2.38 |
| 17 | 12.2 | 82.0 | 258.9 | 6.75 | 3.16 | 1.45 | 2.06 |
| 18 | 6.5 | 64.0 | 286.6 | 9.85 | 4.48 | 1.59 | 2.17 |
| 19 | 8.7 | 86.8 | 271.9 | 10.04 | 3.13 | 1.83 | 2.16 |
| 20 | 8.7 | 85.1 | 267.5 | 9.79 | 3.14 | 1.81 | 2.14 |
| 21 | 7.4 | 84.4 | 268.1 | 11.41 | 3.18 | 1.98 | 2.15 |
| 22 | 7.9 | 86.8 | 275.2 | 10.98 | 3.17 | 1.86 | 2.18 |
| 23 | 6.5 | 87.9 | 296.7 | 13.58 | 3.38 | 1.98 | 2.30 |
| 24 | 8.1 | 87.9 | 275.4 | 10.84 | 3.13 | 1.88 | 2.19 |
| C1 | 17.8 | 89.7 | 268.3 | 5.04 | 2.99 | 1.31 | 2.10 |
| C2 | 17.4 | 95.3 | 274.9 | 5.46 | 2.89 | 1.28 | 2.14 |
| C3 | 22.6 | 88.9 | 263.9 | 3.93 | 2.97 | 1.25 | 2.06 |
| C4 | 22.5 | 98.6 | 300.9 | 4.38 | 3.05 | 1.24 | 2.25 |

TABLE 4
Molecular Weight Characterization (kg/mol) - LMW component

| | | | | | | LMW | SCB |
|---|---|---|---|---|---|---|---|
| Example | Mn | Mw | Mz | Mw/Mn | Mz/Mw | Fraction | (avg) |
| 1 | 10.1 | 37.3 | 77.4 | 3.70 | 2.08 | 0.75 | 1.2 |
| 2 | 17.7 | 62.0 | 127.3 | 3.51 | 2.05 | 0.78 | 1.0 |
| 3 | 11.7 | 44.7 | 96.6 | 3.81 | 2.16 | 0.71 | 1.2 |
| 4 | 6.2 | 25.0 | 55.6 | 4.06 | 2.23 | 0.57 | 1.1 |
| 5 | 5.6 | 22.2 | 50.4 | 3.99 | 2.27 | 0.65 | 1.3 |
| 6 | 5.1 | 19.7 | 42.7 | 3.86 | 2.17 | 0.59 | 1.6 |
| 7 | 3.1 | 11.7 | 26.2 | 3.73 | 2.24 | 0.44 | 1.1 |
| 8 | 8.6 | 34.4 | 75.8 | 3.99 | 2.20 | 0.58 | 1.2 |
| 9 | 7.6 | 29.1 | 63.9 | 3.82 | 2.19 | 0.65 | 1.4 |
| 10 | 5.3 | 19.5 | 42.6 | 3.69 | 2.18 | 0.43 | 1.5 |
| 11 | 4.5 | 17.7 | 39.5 | 3.94 | 2.23 | 0.61 | 1.5 |
| 12 | 3.2 | 12.4 | 30.4 | 3.89 | 2.45 | 0.41 | 1.3 |
| 13 | 4.7 | 18.7 | 45.1 | 4.00 | 2.41 | 0.62 | 1.3 |
| 14 | 5.3 | 20.2 | 42.9 | 3.81 | 2.12 | 0.55 | 1.6 |
| 15 | 4.3 | 16.8 | 36.1 | 3.87 | 2.15 | 0.58 | 1.8 |
| 16 | 7.4 | 28.7 | 60.5 | 3.89 | 2.10 | 0.53 | 1.4 |
| 17 | 10.0 | 39.0 | 81.1 | 3.89 | 2.08 | 0.74 | 1.6 |
| 18 | 5.1 | 19.6 | 41.9 | 3.87 | 2.14 | 0.71 | 1.6 |
| 19 | 5.9 | 24.8 | 62.2 | 4.20 | 2.51 | 0.61 | 1.7 |
| 20 | 5.8 | 24.7 | 61.1 | 4.24 | 2.48 | 0.62 | 1.7 |
| 21 | 4.5 | 18.6 | 46.1 | 4.12 | 2.48 | 0.57 | 1.8 |
| 22 | 5.6 | 23.5 | 58.4 | 4.19 | 2.49 | 0.60 | 1.7 |
| 23 | 4.6 | 19.4 | 50.7 | 4.24 | 2.62 | 0.59 | 1.4 |
| 24 | 5.7 | 24.9 | 65.6 | 4.40 | 2.64 | 0.60 | 1.9 |

TABLE 5
Molecular Weight Characterization (kg/mol) - HMW component

| | | | | | | HMW | SCB |
|---|---|---|---|---|---|---|---|
| Example | Mn | Mw | Mz | Mw/Mn | Mz/Mw | Fraction | (avg) |
| 1 | 94.9 | 232.7 | 438.2 | 2.45 | 1.88 | 0.25 | 3.9 |
| 2 | 100.1 | 250.9 | 476.3 | 2.51 | 1.90 | 0.22 | 3.5 |
| 3 | 86.0 | 229.5 | 450.3 | 2.67 | 1.96 | 0.29 | 4.0 |
| 4 | 84.3 | 210.5 | 392.8 | 2.50 | 1.87 | 0.43 | 3.6 |
| 5 | 82.7 | 202.7 | 370.1 | 2.45 | 1.83 | 0.35 | 3.8 |
| 6 | 79.1 | 189.4 | 336.7 | 2.39 | 1.78 | 0.41 | 3.9 |
| 7 | 67.4 | 162.9 | 294.3 | 2.42 | 1.81 | 0.56 | 3.9 |
| 8 | 97.0 | 226.3 | 393.8 | 2.33 | 1.74 | 0.42 | 4.3 |
| 9 | 91.4 | 212.5 | 367.1 | 2.33 | 1.73 | 0.35 | 4.1 |
| 10 | 82.2 | 198.0 | 356.8 | 2.41 | 1.80 | 0.57 | 4.4 |
| 11 | 77.6 | 188.8 | 349.1 | 2.43 | 1.85 | 0.39 | 4.4 |
| 12 | 70.2 | 170.9 | 321.6 | 2.43 | 1.88 | 0.59 | 3.9 |
| 13 | 77.8 | 187.6 | 346.1 | 2.41 | 1.84 | 0.38 | 4.0 |
| 14 | 72.0 | 175.2 | 327.3 | 2.43 | 1.87 | 0.45 | 6.0 |
| 15 | 69.0 | 167.9 | 313.7 | 2.43 | 1.87 | 0.42 | 5.6 |
| 16 | 81.8 | 195.0 | 354.1 | 2.38 | 1.82 | 0.47 | 6.1 |
| 17 | 84.4 | 203.3 | 374.7 | 2.41 | 1.84 | 0.26 | 7.8 |
| 18 | 64.3 | 159.5 | 305.1 | 2.48 | 1.91 | 0.29 | 6.8 |
| 19 | 75.0 | 177.7 | 320.1 | 2.37 | 1.80 | 0.39 | 6.3 |
| 20 | 75.6 | 182.8 | 338.7 | 2.42 | 1.85 | 0.38 | 6.5 |
| 21 | 70.0 | 167.5 | 306.2 | 2.39 | 1.83 | 0.43 | 6.1 |
| 22 | 75.7 | 179.4 | 323.3 | 2.37 | 1.80 | 0.40 | 6.6 |
| 23 | 76.1 | 182.8 | 335.5 | 2.40 | 1.84 | 0.41 | 4.5 |
| 24 | 75.8 | 180.2 | 325.8 | 2.38 | 1.81 | 0.40 | 6.6 |

TABLE 6
Rheological Properties at 190° C.

| | Zero shear | Tau(η) | CY-a | Tan d @ 0.1 | Tan d @ 100 |
|---|---|---|---|---|---|
| Example | (Pa-sec) | (sec) | parameter | (degrees) | (degrees) |
| 1 | 1,977 | 0.012 | 0.367 | 10.00 | 1.28 |
| 2 | 5,230 | 0.010 | 0.370 | 10.59 | 1.32 |
| 3 | 4,657 | 0.018 | 0.407 | 10.87 | 1.14 |
| 4 | 6,051 | 0.033 | 0.489 | 13.46 | 0.92 |
| 5 | 3,263 | 0.022 | 0.471 | 14.70 | 1.05 |
| 6 | 4,004 | 0.027 | 0.504 | 16.09 | 0.97 |
| 7 | 4,562 | 0.021 | 0.522 | 20.39 | 1.05 |
| 8 | 8,897 | 0.042 | 0.483 | 11.63 | 0.86 |
| 9 | 4,494 | 0.029 | 0.485 | 13.94 | 0.96 |
| 10 | 10,920 | 0.041 | 0.499 | 12.77 | 0.86 |
| 11 | 2,726 | 0.022 | 0.516 | 19.05 | 1.03 |
| 12 | 6,508 | 0.024 | 0.490 | 15.82 | 1.02 |
| 13 | 5,303 | 0.029 | 0.511 | 16.11 | 0.94 |
| 14 | 3,358 | 0.021 | 0.522 | 20.21 | 1.04 |
| 15 | 2,208 | 0.016 | 0.521 | 22.90 | 1.14 |
| 16 | 5,691 | 0.028 | 0.525 | 17.83 | 0.95 |
| 17 | 2,186 | 0.012 | 0.463 | 18.25 | 1.26 |
| 18 | 737 | 0.009 | 0.496 | 26.17 | 1.39 |
| 19 | 2,708 | 0.018 | 0.530 | 22.82 | 1.09 |
| 20 | 2,617 | 0.018 | 0.521 | 21.49 | 1.09 |
| 21 | 2,492 | 0.016 | 0.527 | 23.54 | 1.13 |
| 22 | 2,838 | 0.019 | 0.523 | 21.29 | 1.07 |
| 23 | 2,903 | 0.021 | 0.518 | 19.59 | 1.04 |
| 24 | 2,911 | 0.018 | 0.521 | 21.47 | 1.09 |
| C1 | 1,675 | 0.005 | 0.485 | 31.77 | 1.68 |
| C2 | 2,063 | 0.005 | 0.480 | 30.66 | 1.68 |
| C3 | 1,691 | 0.005 | 0.468 | 28.88 | 1.71 |
| C4 | 2,555 | 0.006 | 0.467 | 25.28 | 1.56 |

TABLE 7
Rheological Properties at 190° C.

| | η @ 0.1 | η @ 100 | η @ HLMI | η @ 0.1/ |
|---|---|---|---|---|
| Example | (Pa-sec) | (Pa-sec) | (Pa-sec) | η @ 100 |
| 1 | 1,651 | 394 | 58 | 4.19 |
| 2 | 4,420 | 1,110 | 692 | 3.98 |
| 3 | 4,013 | 892 | 373 | 4.50 |
| 4 | 5,478 | 1,086 | 467 | 5.04 |
| 5 | 2,970 | 691 | 154 | 4.30 |
| 6 | 3,695 | 824 | 220 | 4.48 |
| 7 | 4,292 | 1,114 | 561 | 3.85 |
| 8 | 7,915 | 1,376 | 835 | 5.75 |
| 9 | 4,080 | 852 | 244 | 4.79 |
| 10 | 9,853 | 1,772 | 1,547 | 5.56 |
| 11 | 2,552 | 637 | 104 | 4.00 |
| 12 | 5,983 | 1,384 | 930 | 4.32 |
| 13 | 4,900 | 1,061 | 443 | 4.62 |
| 14 | 3,158 | 814 | 235 | 3.88 |
| 15 | 2,091 | 604 | 109 | 3.46 |
| 16 | 5,309 | 1,199 | 619 | 4.43 |
| 17 | 2,024 | 595 | 145 | 3.40 |
| 18 | 702 | 247 | 8 | 2.85 |
| 19 | 2,567 | 715 | 169 | 3.59 |
| 20 | 2,470 | 674 | 141 | 3.66 |
| 21 | 2,365 | 683 | 157 | 3.46 |
| 22 | 2,678 | 719 | 168 | 3.73 |
| 23 | 2,723 | 692 | 140 | 3.93 |
| 24 | 2,747 | 748 | 195 | 3.67 |
| C1 | 1,606 | 674 | 296 | 2.38 |
| C2 | 1,975 | 820 | 440 | 2.41 |
| C3 | 1,612 | 669 | 300 | 2.41 |
| C4 | 2,419 | 913 | 514 | 2.65 |

TABLE 8
SCB and LCB Properties

| | SCB | SCB | SCB | SCB @ Mz/ | LCB/ |
|---|---|---|---|---|---|
| Example | @ Mn | @ Mw | @ Mz | SCB @ Mn | Million TC |
| 1 | 1.10 | 1.98 | 3.09 | 2.81 | 1.0 |
| 2 | 1.23 | 2.07 | 2.74 | 2.22 | 2.1 |
| 3 | 1.00 | 2.12 | 3.45 | 3.44 | 2.1 |
| 4 | 0.81 | 1.97 | 2.90 | 3.59 | 3.1 |
| 5 | 1.05 | 1.97 | 3.42 | 3.25 | 4.7 |
| 6 | 1.72 | 2.50 | 3.48 | 2.02 | 4.2 |
| 7 | 1.52 | 2.62 | 3.68 | 2.42 | 2.8 |
| 8 | 1.67 | 2.61 | 3.59 | 2.15 | 2.4 |
| 9 | 1.40 | 2.35 | 3.47 | 2.48 | 3.2 |
| 10 | 1.68 | 2.83 | 3.72 | 2.22 | 2.5 |
| 11 | 1.79 | 2.69 | 4.08 | 2.28 | 3.9 |
| 12 | 1.29 | 2.66 | 3.61 | 2.79 | 2.5 |
| 13 | 1.70 | 2.39 | 3.41 | 2.00 | 3.0 |
| 14 | 2.21 | 3.59 | 5.35 | 2.42 | 4.8 |
| 15 | 2.17 | 3.44 | 5.42 | 2.50 | 5.9 |
| 16 | 2.08 | 3.61 | 5.31 | 2.55 | 3.6 |
| 17 | 2.09 | 3.28 | 5.53 | 2.64 | 5.6 |
| 18 | 1.94 | 3.03 | 5.42 | 2.79 | 5.1 |
| 19 | 2.14 | 3.47 | 5.31 | 2.48 | 5.2 |
| 20 | 2.15 | 3.59 | 5.55 | 2.58 | 6.0 |
| 21 | 2.24 | 3.73 | 5.77 | 2.57 | 6.0 |
| 22 | 2.21 | 3.62 | 5.71 | 2.59 | 5.9 |
| 23 | 1.61 | 2.57 | 4.00 | 2.48 | 5.7 |
| 24 | 2.22 | 3.73 | 5.70 | 2.57 | 5.6 |
| C1 | 6.06 | 6.06 | 6.01 | 1.00 | 0.6 |
| C2 | 1.53 | 1.61 | 1.67 | 1.06 | 0.4 |
| C3 | — | — | — | — | 0.1 |
| C4 | — | — | — | — | 0.0 |

TABLE 9
ATREF Properties

| | | | Eluted in |
|---|---|---|---|
| | Peak | Eluted <40° C. | 93-95° C. |
| Example | (° C.) | (wt. %) | (wt. %) |
| 1 | 97.5 | 1.0 | 11.1 |
| 2 | 98 | 1.1 | 7.7 |
| 3 | 98 | 2.2 | 10.4 |
| 4 | 96.5 | 2.3 | 18.0 |
| 5 | 96.5 | 3.1 | 16.6 |
| 6 | 96.5 | 3.2 | 17.7 |
| 7 | 95 | 6.1 | 26.9 |
| 8 | 96.5 | 1.9 | 18.3 |
| 9 | 97 | 2.0 | 16.2 |
| 10 | 96 | 2.3 | 23.1 |
| 11 | 96 | 4.1 | 19.0 |
| 12 | 95.5 | 3.6 | 25.0 |
| 13 | 96 | 4.0 | 20.4 |
| 14 | 96 | 2.2 | 19.8 |
| 15 | 95 | 2.9 | 19.8 |
| 16 | 96.5 | 2.0 | 18.5 |
| 17 | 96.5 | 2.3 | 14.1 |
| 18 | 96 | 3.4 | 14.8 |
| 19 | 95.5 | 2.9 | 18.3 |
| 20 | 95.5 | 3.4 | 17.7 |
| 21 | 95 | 2.9 | 19.5 |
| 22 | 95.5 | 2.8 | 17.9 |
| 23 | 95 | 4.2 | 21.2 |
| 24 | 95.5 | 2.5 | 18.9 |
| C1 | 99 | 4.1 | 4.8 |
| C2 | 99.5 | 1.6 | 3.9 |
| C3 | 99 | 3.8 | 5.4 |
| C4 | 100 | 1.9 | 3.9 |

TABLE 10
Tensile, Flex, and Impact Properties

| | Yield | Yield | Tensile | Tensile | Tangent | Tangent | Elongation |
|---|---|---|---|---|---|---|---|
| | Strength | Strength | Modulus | Modulus | Modulus | Modulus | At Break |
| Example | (psi) | (MPa) | (psi) | (MPa) | (psi) | (MPa) | (%) |
| 1 | 3352 | 23.10 | 139,200 | 959 | 141,200 | 973 | 413 |
| 2 | 3374 | 23.26 | 117,400 | 809 | 126,200 | 870 | 383 |
| 3 | 3350 | 23.09 | 131,600 | 907 | 139,800 | 964 | 303 |
| 4 | 3682 | 25.38 | 138,400 | 954 | 139,400 | 961 | 106 |
| 5 | 3522 | 24.28 | 171,400 | 1181 | 156,400 | 1078 | 433 |
| 6 | 3630 | 25.02 | 148,600 | 1024 | 147,000 | 1013 | 392 |
| 7 | — | — | 136,000 | 937 | 139,400 | 961 | 11 |
| 8 | 3692 | 25.45 | 139,400 | 961 | 127,200 | 877 | 50 |
| 9 | 3530 | 24.33 | 146,400 | 1009 | 143,800 | 991 | 344 |
| 10 | — | — | 149,200 | 1028 | 120,800 | 833 | 14 |
| 11 | 3654 | 25.19 | 161,400 | 1113 | 152,200 | 1049 | 435 |
| 12 | — | — | 169,400 | 1168 | 121,400 | 837 | 9 |
| 13 | 3840 | 26.47 | 175,600 | 1210 | 139,800 | 964 | 14 |
| 14 | 3450 | 23.79 | 158,400 | 1092 | 131,600 | 907 | 17 |
| 15 | 3392 | 23.39 | 176,600 | 1218 | 140,200 | 967 | 347 |
| 16 | 3270 | 22.55 | 144,000 | 993 | 111,300 | 768 | 41 |
| 17 | 3276 | 22.59 | 174,400 | 1202 | 133,700 | 922 | 177 |
| 18 | 3346 | 23.07 | 190,200 | 1311 | 154,500 | 1065 | 277 |
| 19 | 3284 | 22.64 | 164,000 | 1131 | 131,900 | 909 | 103 |
| 20 | 3322 | 22.90 | 173,200 | 1194 | 131,700 | 908 | 188 |
| 21 | 3432 | 23.66 | 167,000 | 1151 | 132,400 | 913 | 209 |
| 22 | 3304 | 22.78 | 163,200 | 1125 | 129,600 | 893 | 123 |
| 23 | 3622 | 24.97 | 181,000 | 1248 | 147,200 | 1015 | 52 |
| 24 | 3278 | 22.60 | 164,200 | 1132 | 126,100 | 870 | 54 |
| C1 | 2614 | 18.01 | 127,000 | 875 | 107,000 | 737 | 453 |
| C2 | 3280 | 22.60 | 173,000 | 1192 | 147,200 | 1014 | 516 |

TABLE 11
Tensile, Flex, and Impact Properties

| | Impact - Total | Impact - Total | Secant | Secant |
|---|---|---|---|---|
| Exam- | Energy to Break | Energy to Break | Modulus | Modulus |
| ple | @ 23° C. (Joule) | @ −40° C. (Joule) | 1% (psi) | 1% (MPa) |
| 1 | 40.1 | 41.3 | 125,200 | 863 |
| 2 | 37.5 | 46.5 | 112,200 | 773 |
| 3 | 39.1 | 46.8 | 123,400 | 851 |
| 4 | 39.1 | 52.2 | 123,400 | 851 |
| 5 | 37.8 | 43.3 | 138,200 | 953 |
| 6 | 39.5 | 43.4 | 130,400 | 899 |
| 7 | 36.9 | 49.1 | 123,400 | 851 |
| 8 | 37.6 | 42.0 | 112,200 | 773 |
| 9 | 39.2 | 42.8 | 127,400 | 878 |
| 10 | 36.8 | 52.0 | 107,200 | 739 |
| 11 | 38.3 | 48.8 | 136,000 | 937 |
| 12 | 36.9 | 42.4 | 107,800 | 743 |
| 13 | 37.7 | 44.8 | 124,200 | 856 |
| 14 | 44.4 | 62.3 | 115,200 | 794 |
| 15 | 50.2 | 51.6 | 123,400 | 851 |
| 16 | 39.9 | 49.8 | 97,200 | 670 |
| 17 | 41.7 | 48.7 | 117,800 | 812 |
| 18 | 39.4 | 6.5 | 137,300 | 946 |
| 19 | 37.8 | 45.1 | 115,700 | 798 |
| 20 | 39.8 | 47.2 | 115,800 | 799 |
| 21 | 37.3 | 48.5 | 116,400 | 802 |
| 22 | 36.2 | 44.3 | 114,300 | 788 |
| 23 | 42.8 | 48.2 | 129,600 | 894 |
| 24 | 38.2 | 40.5 | 111,000 | 765 |
| C1 | 28.8 | 41.8 | 94,700 | 653 |
| C2 | 37.5 | 28.3 | 129,200 | 890 |

The invention is described herein with reference to numerous aspects and specific examples. Many variations will suggest themselves to those skilled in the art in light of the detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. An ethylene polymer having (or characterized by) a melt index in a range from 0.8 to 8 g/10 min, a ratio of Mw/Mn in a range from 6 to 20, and (i) a density in a range from 0.94 to 0.96 g/cm³ and an environmental stress crack resistance (ESCR) of at least 4,000 hr (ASTM D1693, condition A, 10% Igepal) and/or an environmental stress crack resistance (ESCR) of at least 7,000 hr (ASTM D1693, condition A, 100% Igepal), or (ii) a density in a range from 0.949 to 0.96 g/cm³ and an environmental stress crack resistance (ESCR) of at least 2,500 hr (ASTM D1693, condition A, 10% Igepal) and/or an environmental stress crack resistance (ESCR) of at least 5,000 hr (ASTM D1693, condition A, 100% Igepal).

Aspect 2. An ethylene polymer having (or characterized by) a melt index in a range from 0.8 to 8 g/10 min, a density in a range from 0.94 to 0.96 g/cm³, a ratio of Mw/Mn in a range from 6 to 20, and a CY-a parameter in a range from 0.35 to 0.53.

Aspect 3. An ethylene polymer having (or characterized by) a melt index in a range from 0.8 to 8 g/10 min, a density in a range from 0.94 to 0.96 g/cm³, a ratio of Mw/Mn in a range from 6 to 20, and a PSP2 value in a range from 5 to 8.5.

Aspect 4. An ethylene polymer having (or characterized by) a melt index in a range from 0.8 to 8 g/10 min, a density in a range from 0.94 to 0.96 g/cm³, a ratio of Mw/Mn in a range from 6 to 20, and from 7 to 30 wt. % of the polymer eluting between 93 and 95° C. in an ATREF profile.

Aspect 5. An ethylene polymer having (or characterized by) a melt index in a range from 0.8 to 8 g/10 min, a density in a range from 0.94 to 0.96 g/cm³, a ratio of Mw/Mn in a range from 6 to 20, and an IVc from 2 to 3 dL/g.

Aspect 6. An ethylene polymer having (or characterized by) a melt index in a range from 0.8 to 8 g/10 min, a density in a range from 0.94 to 0.96 g/cm³, a ratio of Mw/Mn in a range from 6 to 20, and a strain hardening modulus (SHM) in a range from 19 to 47 MPa.

Aspect 7. An ethylene polymer having (or characterized by) a melt index in a range from 2 to 8 g/10 min, a density in a range from 0.94 to 0.96 g/cm³, a ratio of Mw/Mn in a range from 6 to 20, and a tan δ at 0.1 sec⁻¹ in a range from 8 to 24 degrees.

Aspect 8. An ethylene polymer having (or characterized by) a melt index in a melt index in a range from 2 to 8 g/10 min, a density in a range from 0.948 to 0.96 g/cm³, a ratio of Mw/Mn in a range from 6 to 20, and a Mz in a range from 275,000 to 420,000 g/mol.

Aspect 9. The polymer defined in any one of the preceding aspects, wherein the ethylene polymer has a strain hardening modulus (SHM) in any range disclosed herein, e.g., from 19 to 47, from 19 to 45, from 20 to 42, from 20 to 40, from 22 to 45, from 22 to 42 or, from 22 to 40 MPa.

Aspect 10. The polymer defined in any one of the preceding aspects, wherein the ethylene polymer has a melt index in any range disclosed herein, e.g., from 0.8 to 6, from 1 to 8, from 1.5 to 8, from 1.5 to 6, from 2 to 8, or from 2 to 6 g/10 min.

Aspect 11. The polymer defined in any one of the preceding aspects, wherein the ethylene polymer has a HLMI in any range disclosed herein, e.g., from 30 to 400, from 40 to 350, from 50 to 350, from 70 to 350, or from 70 to 300 g/10 min.

Aspect 12. The polymer defined in any one of the preceding aspects, wherein the ethylene polymer has a ratio of HLMI/MI in any range disclosed herein, e.g., from 25 to 75, from 25 to 68, from 28 to 75, from 28 to 68, from 30 to 75, from 30 to 70, or from 30 to 65.

Aspect 13. The polymer defined in any one of the preceding aspects, wherein the ethylene polymer has a density in any range disclosed herein, e.g., from 0.94 to 0.96, from 0.942 to 0.96, from 0.945 to 0.96, from 0.945 to 0.958, from 0.945 to 0.956, from 0.948 to 0.96, from 0.948 to 0.958, from 0.949 to 0.96, or from 0.949 to 0.956 g/cm³.

Aspect 14. The polymer defined in any one of the preceding aspects, wherein the ethylene polymer has a ratio of Mw/Mn in any range disclosed herein, e.g., from 6 to 20, from 6 to 18, from 6 to 16, from 7 to 20, from 7 to 18, from 8 to 18, from 8 to 16, from 9 to 20, or from 9 to 16.

Aspect 15. The polymer defined in any one of the preceding aspects, wherein the ethylene polymer has a ratio of Mz/Mw in any range disclosed herein, e.g., from 2.2 to 4.2, from 2.4 to 4, from 2.4 to 3.8, from 2.6 to 4, from 2.6 to 3.8, or from 2.8 to 3.7.

Aspect 16. The polymer defined in any one of the preceding aspects, wherein the ethylene polymer has a Mn in any range disclosed herein, e.g., from 5,000 to 25,000, from 5,000 to 20,000, from 5,000 to 15,000, from 5,000 to 10,000, from 6,000 to 20,000, from 6,000 to 15,000, or from 6,000 to 10,000 g/mol.

Aspect 17. The polymer defined in any one of the preceding aspects, wherein the ethylene polymer has a Mw in any range disclosed herein, e.g., from 75,000 to 150,000, from 75,000 to 120,000, from 80,000 to 130,000, from 80,000 to 110,000, from 85,000 to 140,000, from 85,000 to 130,000, or from 85,000 to 110,000 g/mol.

Aspect 18. The polymer defined in any one of the preceding aspects, wherein the ethylene polymer has a Mz in any range disclosed herein, e.g., from 240,000 to 420,000, from 240,000 to 375,000, from 240,000 to 350,000, from 275,000 to 420,000, from 275,000 to 390,000, from 275,000 to 375,000, or from 300,000 to 390,000 g/mol.

Aspect 19. The polymer defined in any one of the preceding aspects, wherein the ethylene polymer has an environmental stress crack resistance (ESCR) in any range disclosed herein, e.g., at least 1,000 hr, at least 2,500 hr, at least 4,000 hr, at least 5,000 hr, at least 7,000 hr, or at least 10,000 hr (condition A, 100%).

Aspect 20. The polymer defined in any one of the preceding aspects, wherein the ethylene polymer has an environmental stress crack resistance (ESCR) in any range disclosed herein, e.g., at least 500 hr, at least 1,000 hr, at least 2,500 hr, at least 3,000 hr, at least 3,500 hr, at least 4,000 hr, or at least 5,000 hr (condition A, 10%).

Aspect 21. The polymer defined in any one of the preceding aspects, wherein the ethylene polymer has a PSP4 value in any range disclosed herein, e.g., from 0.2 to 0.9, from 0.3 to 0.9, from 0.3 to 0.85, from 0.35 to 0.85, or from 0.4 to 0.8.

Aspect 22. The polymer defined in any one of the preceding aspects, wherein the ethylene polymer has a PSP2 value in any range disclosed herein, e.g., from 5 to 10, from 5 to 8.5, from 5 to 8, from 5.5 to 9, from 5.5 to 8.5, from 6 to 9.5, from 6 to 8.5, or from 6 to 8.3.

Aspect 23. The polymer defined in any one of the preceding aspects, wherein the ethylene polymer has an ATREF profile characterized by from 7 to 30 wt. %, from 7 to 28 wt. %, from 9 to 30 wt. %, from 9 to 28 wt. %, from 12 to 30 wt. %, or from 14 to 28 wt. %, of the polymer eluting between 93 and 95° C.

Aspect 24. The polymer defined in any one of the preceding aspects, wherein the ethylene polymer has an ATREF profile characterized by a peak ATREF temperature in any range disclosed herein, e.g., from 93 to 100° C., from 94 to 99° C., from 94 to 98° C., from 94 to 97° C., or from 95 to 98° C.

Aspect 25. The polymer defined in any one of the preceding aspects, wherein the ethylene polymer has an ATREF profile characterized by from 0.25 to 7.5 wt. %, from 0.5 to 7 wt. %, from 1 to 7 wt. %, from 1.5 to 7 wt. %, or from 1.5 to 6.5 wt. %, of the polymer eluting below a temperature of 40° C.

Aspect 26. The polymer defined in any one of the preceding aspects, wherein the ethylene polymer has an IVc in any range disclosed herein, e.g., from 2 to 3.2, from 2 to 3, from 2 to 2.8, from 2.1 to 3, from 2.1 to 2.8, from 2.1 to 2.6, or from 2.2 to 2.8 dL/g.

Aspect 27. The polymer defined in any one of the preceding aspects, wherein the ethylene polymer has an IB parameter in any range disclosed herein, e.g., from 1.1 to 2.3, from 1.2 to 2.2, from 1.2 to 2.1, from 1.4 to 2.2, from 1.5 to 2.3, or from 1.5 to 2.2.

Aspect 28. The polymer defined in any one of the preceding aspects, wherein the ethylene polymer has a tan δ (tan d or tangent delta) at 0.1 sec⁻¹ in any range disclosed herein, e.g., from 8 to 27, from 8 to 24, from 9 to 22, from 10 to 24, from 12 to 24, or from 14 to 22 degrees.

Aspect 29. The polymer defined in any one of the preceding aspects, wherein the ethylene polymer has a tan δ (tan d or tangent delta) at 100 sec⁻¹ in any range disclosed herein, e.g., from 0.7 to 1.5, from 0.8 to 1.4, from 0.8 to 1.2, from 0.9 to 1.4, or from 0.9 to 1.2 degrees.

Aspect 30. The polymer defined in any one of the preceding aspects, wherein the ethylene polymer has a CY-a parameter in any range disclosed herein, e.g., from 0.3 to 0.6, from 0.35 to 0.55, from 0.35 to 0.53, from 0.4 to 0.55, from 0.4 to 0.53, or from 0.45 to 0.53.

Aspect 31. The polymer defined in any one of the preceding aspects, wherein the ethylene polymer has a ratio of viscosity at 0.1 sec⁻¹ (eta @ 0.1 or η @ 0.1) to the viscosity at 100 sec⁻¹ (eta @ 100 or η @ 100) in any range disclosed herein, e.g., from 3 to 7, from 3 to 6.5, from 3 to 6, from 3.5 to 6, from 3.5 to 5.5, or from 3.5 to 5.

Aspect 32. The polymer defined in any one of the preceding aspects, wherein the ethylene polymer has a relaxation time (Tau(eta) or @(i)) in any range disclosed herein, e.g., from 0.006 to 0.06, from 0.008 to 0.05, from 0.008 to 0.04, from 0.01 to 0.05, from 0.01 to 0.04, or from 0.015 to 0.035 sec.

Aspect 33. The polymer defined in any one of the preceding aspects, wherein the ethylene polymer has less than or equal to 8 long chain branches (LCBs), less than or equal to 7 LCBs, less than or equal to 6 LCBs, or less than or equal to 5 LCBs, per 1,000,000 total carbon atoms.

Aspect 34. The polymer defined in any one of the preceding aspects, wherein the ratio of a number of SCBs per 1000 total carbon atoms at Mz to the number of SCBs per 1000 total carbon atoms at Mn is in any range disclosed herein, e.g., from 1.8 to 5, from 1.8 to 4, from 1.8 to 3.5, from 2 to 4, or from 2 to 3.6.

Aspect 35. The polymer defined in any one of the preceding aspects, wherein the ethylene polymer has a yield strength in any range disclosed herein, e.g., from 21 to 28, from 21 to 27, from 22 to 28, from 22 to 27, from 22 to 26, or from 23 to 27 MPa (ASTM D638 Tensile).

Aspect 36. The polymer defined in any one of the preceding aspects, wherein the ethylene polymer has an impact strength at −40° C. in any range disclosed herein, e.g., from 40 to 70, from 40 to 65, from 40 to 63, from 42 to 70, or from 42 to 65 Joules (ASTM D3763 High Speed Puncture).

Aspect 37. The polymer defined in any one of the preceding aspects, wherein the ethylene polymer has a tangent modulus (flex modulus) in any range disclosed herein, e.g., from 750 to 1200, from 750 to 1100, from 800 to 1200, from 800 to 1100, or from 850 to 1050 MPa (ASTM D790 Flexural).

Aspect 38. The polymer defined in any one of the preceding aspects, wherein the ethylene polymer has a 1% secant modulus in any range disclosed herein, e.g., from 650 to 1200, from 700 to 1100, from 650 to 1050, from 700 to 1000, or from 725 to 975 MPa.

Aspect 39. The polymer defined in any one of the preceding aspects, wherein the ethylene polymer has an elongation at break in any range disclosed herein, e.g., from 5 to 600%, from 10 to 500%, from 50 to 550%, from 50 to 450%, from 100 to 500%, or from 200 to 450%.

Aspect 40. The polymer defined in any one of the preceding aspects, wherein the ethylene polymer has a higher molecular weight component and a lower molecular weight component.

Aspect 41. The polymer defined in aspect 40, wherein the higher molecular component has a Mw in any range disclosed herein, e.g., from 100,000 to 300,000, from 125,000 to 280,000, from 150,000 to 250,000, or from 160,000 to 230,000 g/mol.

Aspect 42. The polymer defined in aspect 40 or 41, wherein the higher molecular weight component has a Mn in any range disclosed herein, e.g., from 50,000 to 150,000, from 50,000 to 100,000, from 60,000 to 105,000, or from 60,000 to 90,000 g/mol.

Aspect 43. The polymer defined in any one of aspects 40-42, wherein the higher molecular weight component has a ratio of Mw/Mn in any range disclosed herein, e.g., from 2 to 3, from 2 to 2.8, from 2 to 2.6, from 2.2 to 2.8, or from 2.3 to 2.7.

Aspect 44. The polymer defined in any one of aspects 40-43, wherein the lower molecular weight component has a ratio of Mw/Mn in any range disclosed herein, e.g., from 2.8 to 4.6, from 2.8 to 4.4, from 3 to 4.3, from 3.3 to 4.4, or from 3.3 to 4.1.

Aspect 45. The polymer defined in any one of aspects 40-44, wherein the lower molecular weight component has a Mw in any range disclosed herein, e.g., from 8,000 to 70,000, from 8,000 to 26,000, from 10,000 to 50,000, from 10,000 to 26,000, or from 12,000 to 30,000 g/mol.

Aspect 46. The polymer defined in any one of aspects 40-45, wherein an amount of the lower molecular weight component, based on the total polymer, is in any range of weight percentages disclosed herein, e.g., from 30 to 85 wt. %, from 30 to 75 wt. %, from 38 to 75 wt. %, from 40 to 75 wt. %, or from 40 to 70 wt. %.

Aspect 47. The polymer defined in any one of the preceding aspects, wherein the ethylene polymer has a bimodal molecular weight distribution.

Aspect 48. The polymer defined in any one of the preceding aspects, wherein the ethylene polymer is a single reactor product, e.g., not a post-reactor blend of two polymers, for instance, having different molecular weight characteristics.

Aspect 49. The polymer defined in any one of the preceding aspects, wherein the ethylene polymer comprises an ethylene/α-olefin copolymer.

Aspect 50. The polymer defined in any one of the preceding aspects, wherein the ethylene polymer comprises an ethylene homopolymer, an ethylene/1-butene copolymer, an ethylene/1-hexene copolymer, and/or an ethylene/1-octene copolymer.

Aspect 51. The polymer defined in any one of the preceding aspects, wherein the ethylene polymer comprises an ethylene/1-hexene copolymer.

Aspect 52. The polymer defined in any one of the preceding aspects, wherein the ethylene polymer contains, independently, less than 0.1 ppm (by weight), less than 0.08 ppm, less than 0.05 ppm, or less than 0.03 ppm, of chromium, titanium, vanadium, and magnesium.

Aspect 53. An article comprising the ethylene polymer defined in any one of the preceding aspects.

Aspect 54. An article comprising the ethylene polymer defined in any one of aspects 1-52, wherein the article is an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier.

Aspect 55. An article comprising the ethylene polymer defined in any one of aspects 1-52, wherein the article is an injected molded product, a rotational molded product, or an injection stretch blow molding product.

What is claimed is:

1. An ethylene polymer having:
a melt index in a range from 0.8 to 8 g/10 min;
a ratio of Mw/Mn in a range from 6 to 20; and
(i) a density in a range from 0.94 to 0.96 g/cm³ and an environmental stress crack resistance (ESCR) of at least 4,000 hr (ASTM D1693, condition A, 10% Igepal) and/or an environmental stress crack resistance (ESCR) of at least 7,000 hr (ASTM D1693, condition A, 100% Igepal); or
(ii) a density in a range from 0.949 to 0.96 g/cm³ and an environmental stress crack resistance (ESCR) of at least 2,500 hr (ASTM D1693, condition A, 10% Igepal) and/or an environmental stress crack resistance (ESCR) of at least 5,000 hr (ASTM D1693, condition A, 100% Igepal).

2. The polymer of claim 1, wherein the polymer has:
the density from 0.94 to 0.96 g/cm³;
the environmental stress crack resistance (ESCR) of at least 4,000 hr (ASTM D1693, condition A, 10% Igepal); and
the environmental stress crack resistance (ESCR) of at least 7,000 hr (ASTM D1693, condition A, 100% Igepal).

3. The polymer of claim 1, wherein the polymer has:
the density from 0.949 to 0.96 g/cm³;
the environmental stress crack resistance (ESCR) of at least 2,500 hr (ASTM D1693, condition A, 10% Igepal); and
the environmental stress crack resistance (ESCR) of at least 5,000 hr (ASTM D1693, condition A, 100% Igepal).

4. The polymer of claim 1, wherein:
the melt index is from 2 to 8 g/10 min; and
the ethylene polymer has a ratio of HLMI/MI from 30 to 75.

5. The polymer of claim 1, wherein the ethylene polymer has:
a PSP2 value in a range from 5 to 8.5; or
an IVc in a range from 2 to 3 dL/g; or
a strain hardening modulus (SHM) in a range from 19 to 47 MPa; or
from 7 to 30 wt. % of the polymer eluting between 93 and 95° C. in an ATREF profile;
or any combination thereof.

6. The polymer of claim 1, wherein the ethylene polymer has a Mw in a range from 75,000 to 120,000 g/mol.

7. The polymer of claim 1, wherein the ethylene polymer has:
a ratio of a number of SCBs per 1000 total carbon atoms at Mz to a number of SCBs per 1000 total carbon atoms at Mn in a range from 1.8 to 4; and
less than or equal to 8 LCBs per 1,000,000 total carbon atoms.

8. The polymer of claim 1, wherein the ethylene polymer has:
a yield strength in a range from 21 to 28 MPa (ASTM D638 Tensile); and
an impact strength at −40° C. in a range from 40 to 70 J (ASTM D3763 High Speed Puncture).

9. The polymer of claim 1, wherein the ethylene polymer has:
a tangent modulus (flex modulus) in a range from 750 to 1200 MPa (ASTM D790 Flexural); and
an impact strength at −40° C. in a range from 40 to 70 J (ASTM D3763 High Speed Puncture).

10. The polymer of claim 1, wherein the ethylene polymer has a higher molecular weight component and a lower molecular weight component.

11. The polymer of claim 1, wherein the ethylene polymer comprises an ethylene homopolymer, an ethylene/1-butene copolymer, an ethylene/1-hexene copolymer, and/or an ethylene/1-octene copolymer.

12. The polymer of claim 1, wherein the ethylene polymer contains, independently, less than 0.1 ppm by weight of chromium, titanium, vanadium, and magnesium.

13. An article of manufacture comprising the ethylene polymer of claim 1.

14. The article of claim 13, wherein the article is a bottle, a container, or a drum.

15. An ethylene polymer having:
a melt index in a range from 0.8 to 8 g/10 min;
a density in a range from 0.94 to 0.96 g/cm³;
a ratio of Mw/Mn in a range from 6 to 20; and
a CY-a parameter in a range from 0.35 to 0.53.

16. The polymer of claim 15, wherein:
the melt index is from 2 to 8 g/10 min;
the ratio of Mw/Mn is from 8 to 18; and
the CY-a parameter is from 0.4 to 0.53.

17. An ethylene polymer having:
a melt index in a range from 2 to 8 g/10 min;
a density in a range from 0.94 to 0.96 g/cm³;
a ratio of Mw/Mn in a range from 6 to 20; and
a tan δ at 0.1 sec⁻¹ in a range from 8 to 24 degrees.

18. The polymer of claim 17, wherein:
the ratio of Mw/Mn is from 8 to 18; and
the tan δ at 0.1 sec⁻¹ is from 14 to 22 degrees.

19. An ethylene polymer having:
a melt index in a range from 2 to 8 g/10 min;
a density in a range from 0.948 to 0.96 g/cm³;
a ratio of Mw/Mn in a range from 6 to 20; and
a Mz in a range from 275,000 to 420,000 g/mol.

20. The polymer of claim 19, wherein:
the ratio of Mw/Mn is from 8 to 18; and
the Mz is from 275,000 to 375,000 g/mol.
